(19) United States
(12) Patent Application Publication
(10) Pub. No.: US 2025/0370256 A1
(43) Pub. Date: Dec. 4, 2025

(54) AUTOSTEREOSCOPIC DISPLAY DEVICE WITH PARTITIONING BACKLIGHT

(71) Applicants: E-LEAD ELECTRONIC CO., LTD., CHANGHUA (TW); Far Vision Technology CO., LTD., Taichung City (TW)

(72) Inventor: Stephen CHEN, CHANGHUA (TW)

(21) Appl. No.: 19/184,413

(22) Filed: Apr. 21, 2025

(30) Foreign Application Priority Data
May 30, 2024 (TW) 113119965

(51) Int. Cl. G02B 27/01

(52) U.S. Cl. CPC G02B 27/0101

(57) ABSTRACT

An autostereoscopic display device with partitioning backlight is adapted to the use of an imaging semi-reflective mirror. In the autostereoscopic display device with partitioning backlight, a display includes a main display module and a light shield module. The light shield module is stacked with the light incident side or the light exit side of the main display module. The display defines a plurality of regions, and the plurality of regions display time-divisionally and are collocated with a plurality of backlight sources to perform the corresponding switching, thereby achieving the effect of displaying partitioned image. The problem that the afterimages and the crosstalk arise from the insufficient response speed of the main display module when a left eye parallax image and a right eye parallax image are quickly switched is solved, and the brightness of the image during displaying may be adjusted by changing the display time of the display regions.

### TECHNICAL FIELD OF THE INVENTION

The present disclosure is related to an autostereoscopic display device, and more precisely, the present disclosure is related to an autostereoscopic display device with backlight real-imaging.

### DESCRIPTION OF THE PRIOR ART

As shown in FIG. 1A and FIG. 1B, the conventional head-up display (HUD) utilizes a backlight source 01 to emit a backlight beam, the backlight beam passes through a display panel 03 to form an image beam, and the image beam is reflected by an imaging concave mirror 5. The imaging concave mirror 5 is a reflective mirror with a concave surface. The image of the display panel 03 forms a corresponding virtual image behind the imaging concave mirror 5, and the backlight source 01 forms a real image of the backlight source on the optical path in front of the imaging concave mirror 5.

An imaging semi-reflective mirror is configured to partially reflect the image beam from the imaging concave mirror to the eyes of a viewer and to facilitate the light of the scenery in front of the viewer to partially transmit to the eyes of the viewer. The imaging semi-reflective mirror may be the windshield WS as shown in FIG. 1A or the combiner C as shown in FIG. 1B. After the virtual image on the rear of the imaging concave mirror 5 is reflected by the imaging semi-reflective mirror (the windshield or the combiner), the virtual image G_im is formed on the side of the imaging semi-reflective mirror far away from the viewer. After the real image of the backlight source in front of the imaging concave mirror 5 is reflected by the imaging semi-reflective mirror, the real image of the backlight source focuses and is formed on the side of the imaging semi-reflective mirror close to the viewer, i.e., an eye box EB.

When the eyes of the viewer are located on the position of the eye box, i.e., the actual focus of the light emitted by the backlight source, the brightest and the clearest virtual image may be seen.

In order to form the real image of the backlight source in front of the imaging concave mirror by the backlight source, the distance between the backlight source and the imaging concave mirror needs to be greater than the focal length of the imaging concave mirror, and thus, it is more difficult for a car dashboard with limited space.

As shown in FIG. 1C, the conventional autostereoscopic head-up display device with directional backlight source, a directional backlight source array is used to serve as the backlight source 01 and collocates with the display panel 03 having fast response time, and the directional backlight source array projects a directional backlight beam B on the display panel 03. The display panel 03 quickly switches between left eye parallax image and right eye parallax image, and after the directional backlight beam B passes through the display panel 03, a directional image beam D with image information is formed. The directional image beam D is reflected by the imaging concave mirror 5 and the imaging semi-reflective mirror 7 to form the real image of the backlight source on the side of the imaging semi-reflective mirror 7 facing the viewer, i.e., an eye box array EBA, and to form the virtual image G_im on the side of the imaging semi-reflective mirror far away from the viewer. When the left eye and the right eye of the viewer lies within the region of the eye box array EBA, the left eye and the right eye of the viewer respectively see a left eye parallax virtual image and a right eye parallax virtual image, and the brain of the viewer would integrate the left eye parallax virtual image and the right eye parallax virtual image into an integrated image, and the integrated image would be determined as a 3D image by the brain of the viewer.

The reflected light or emitting light from the backlight source array is reflected by the imaging concave mirror 5 to form the real image of the backlight source array in front of the imaging concave mirror 5, and then, the real image of the backlight source array is projected on the eye box array EBA of the viewer after being reflected by the imaging semi-reflective mirror 7. After the right eye parallax image and the left eye parallax image of the display panel 03 is reflected by the imaging concave mirror 5, the first left eye parallax virtual image and the first right eye parallax virtual image are formed on the rear of the imaging concave mirror 5, and then, the reflected right eye parallax image and the reflected left eye parallax image are reflected by the imaging semi-reflective mirror 7 to form the second left eye parallax virtual image and the second right eye parallax virtual image G_im on the side of the imaging semi-reflective mirror far away from the viewer. An eye tracking module 6 detects the relative position information of the left eye, the right eye and the eye tracking module. A control operation module 61 receives the relative position information of the left eye, the right eye and the eye tracking module and obtains the left eye position E_L and the right eye position E_R of the viewer in the space by distinguishing, calculating, a lookup table or speculating. Afterwards, the corresponding left eye small eye box EB_L and the corresponding right cyc small eye box EB_R within the eye box array EBA are obtained according to the left eye position E_L and the right eye position E_R, and a left eye backlight source Led_L and a right eye backlight source Led_R are obtained according to the left eye small eye box EB_L and the right eye small eye box EB_R. When the display panel 03 displays the left eye parallax virtual image, the left eye backlight source Led_L is lit. When the display panel 03 displays the right eye parallax virtual image, the right eye backlight source Led_R is lit. The switching time of the left eye parallax virtual image and the right eye parallax virtual image is shorter than the persistence of vision of the eye so that the left eye and the right eye respectively continue to see the left eye parallax virtual image and the right eye parallax virtual image.

The switching time interval of alternately displaying the left eye parallax image and the right eye parallax image by the display module is short, but the responses of liquid crystals require time. If some of the liquid crystals are too late to finish switching, another eye would see the region in a not yet switched state (the partial region of a previous scene) or the region in a switching state, thereby generating afterimages and crosstalk.

In sum, in order to achieve the bright and clear autostereoscopic image, the problem of the needed distance between the backlight source and the imaging concave mirror and the problem of insufficient display panel response time, which results in afterimages and crosstalk, requires a solution.

### SUMMARY

Based on the aforementioned objects, the present disclosure provides an autostereoscopic display device.

The autostereoscopic display device is adapted to an imaging semi-reflective mirror and includes a backlight module, an off-axis dual mirror module, a display, an imaging concave mirror, an eye tracking module, and a control operation module.

The backlight module emits a backlight beam and includes a backlight source array constituted by a plurality of backlight sources.

The off-axis dual mirror module includes a first mirror and a second curved mirror. The first mirror departs from the optical axis of the second curved mirror, and the second curved mirror departs from the optical axis of the first mirror. The first mirror and the second curved mirror sequentially reflect the backlight beam to form a directional backlight beam.

The display includes a main display module and a light shield module which are stacked upon each other. The main display module alternately displays a left eye parallax image and a right eye parallax image, and the directional backlight beam passes through the display to form an image beam.

The imaging concave mirror reflects the image beam.

The eye tracking module detects the relative position information of a left eye, a right eye and the eye tracking module.

The control operation module receives the relative position information from the eye tracking module and outputs a left eye position and a right eye position in space.

The off-axis dual mirror module is configured to facilitate the backlight module to form a virtual image of the backlight source array, and the equivalent distance between the virtual image of the backlight source array and the imaging concave mirror is greater than the focal length of the imaging concave mirror. The reflected backlight beam from the off-axis dual mirror module, which also may be considered as the backlight beam of the backlight source array generating form the position of the virtual image of the backlight source array, is reflected by the imaging concave mirror and the imaging semi-reflective mirror, and then projects and converges on a backlight focal plane which is located on one side of the imaging semi-reflective mirror close to a viewer to form the real image of the backlight module. Hence, the real image of the backlight module defines an eye box array including a plurality of small eye boxes.

In addition, the equivalent distance between the main display module and the imaging concave mirror is less than the focal length of the imaging concave mirror. According to the left eye parallax image and the right eye parallax image, a left eye parallax virtual image and a right eye parallax virtual image are formed on one side of the imaging semi-reflective mirror far away from the eye box array.

In addition, the polarizer of the display close to a light incident side is a reflective polarizer, and there is only one polarizer between the liquid crystal layer of the main display module and the liquid crystal layer of the light shield module.

In addition, the main display module defines a plurality of display regions, the light shield module defines a plurality of switch regions, and each of the plurality of switch regions corresponds to one display region. When the main display module displays an image, at least one of the plurality of switch regions is time-divisionally selected to control at least one display region to time-divisionally project the image beam, and the others of the plurality of switch regions shade the corresponding display regions in the main display module which are in a switching state or a not yet switched state.

In addition, when the main display module displays one of the left eye parallax image and the right eye parallax image, at least one of the plurality of switch regions is time-divisionally selected to control at least one display region to time-divisionally project the image beam, and the others of the plurality of switch regions shade the corresponding display regions in the main display module which displays the other of the left eye parallax image and the right eye parallax image.

In addition, by collocating each display region with the corresponding backlight sources at the same position or different positions, another group of small eye boxes are defined outside the space of the eye box array on two sides of the backlight focal plane, and the another group of small eye boxes and the eye box array collaboratively define an extension eye box array with a wider scope so that the complete left eye parallax image or the complete right eye parallax image may be also seen at the position in the space far away from the backlight focal plane.

In addition, the small eye boxes at different positions within the eye box array or the extension eye box array may be switched to correspond with the movement of the eyes of the viewer in upward, downward, left, right, forward and backward directions.

In addition, the control operation module obtains a left eye box and a right eye box according to the left eye position, the right eye position and the extension eye box array, and obtains a left eye matrix and a right eye matrix according to a small eye box-display region-backlight source matrix table. The left eye matrix and the right eye matrix include the corresponding display regions, the corresponding switch regions and the corresponding backlight sources. The corresponding display regions, the corresponding switch regions and the corresponding backlight sources are controlled to respectively display the left eye parallax image and the right eye parallax image.

In addition, the corresponding small eye boxes are lit according to the moving position of the left eye or the moving position of the right eye. The different small eye boxes are switched to correspond eye displacement including the displacement in a 2D direction or a 3D direction, and the position of the eyes may be tracked in order to project the image to that position.

In addition, the backlight module further includes a conical reflector array including a plurality of conical reflectors with different tilted angles, and the corresponding tilted angle of each of the plurality of conical reflectors increases as each of the plurality of conical reflectors goes away from the center of the conical reflector array.

In addition, the backlight module further includes a conical reflector array, a deflection lens array and a convergent lens array which are sequentially disposed from the light exit side of the backlight source array.

In addition, the second curved mirror is a concave mirror, the first mirror is a concave mirror, a convex mirror or a flat mirror, and the imaging position of the backlight module after being reflected by the first mirror lies within the focal length of the second curved mirror.

In addition, the optical path where the backlight beam travels between the backlight module and the first mirror and the optical path where the backlight beam travels between the second curved mirror and the display module may cross or not cross.

In addition, the light shield module is stacked on the light incident side or the light exit side of the main display module.

In addition, there is optical glue between the main display module and the light shield module, and there is no polarizer between the optical glue and the liquid crystal layer of the main display module or between the optical glue and the liquid crystal layer of the light shield module.

In addition, adjusting the activation time of the switch region or adjusting the activation time of the backlight source may control the brightness of the seen left eye parallax virtual image and the seen right eye parallax virtual image.

In addition, the switching speed of liquid crystals of the main display module is slower than the switching speed of liquid crystals of the light shield module.

In addition, adjacent 2n+1 small eye boxes arranged in the left and right direction (horizontal direction), or arranged in upper and lower direction (vertical direction) are used to correspond to one eye, where n>0 and n is a positive integer. The central small eye box of 2n+1 small eye boxes correspond to the pupil of the left eye or the right eye, and 2n small eye boxes except the central small eye box are located on the upper side and the lower side of the central small eye box or the left side and the right side of the central small eye box.

In addition, the main display module alternately displays the left eye parallax image and the right eye parallax image, and the switching time interval of projecting the image beam on the same eye position by each of the plurality of display regions is less than 41.67 ms.

In addition, the imaging semi-reflective mirror is a windshield or a combiner and is configured to partially reflect the image beam from the imaging concave mirror to the eyes of the viewer and to facilitate the light of the scenery in front of the viewer to partially transmit to the eyes of the viewer.

### BRIEF DESCRIPTION OF DRAWINGS

FIG. 1A and FIG. 1B are the schematic diagrams of the conventional backlit head-up display collocating with the imaging semi-reflective mirror.

FIG. 1C is the schematic diagrams of the conventional autostereoscopic head-up display device with directional backlight source.

FIG. 2A, FIG. 2B, FIG. 2C and FIG. 2D are schematic diagrams of an off-axis dual mirror module.

FIG. 3A is the schematic diagram of the backlit display device collocating with the off-axis dual mirror module.

FIG. 3B is the schematic diagram of the beam of a backlight source which passes through and does not pass through the off-axis dual mirror module respectively.

FIG. 4A, FIG. 4B, FIG. 4C and FIG. 4D are schematic diagrams of a directional backlight source array module.

FIG. 5A, FIG. 5B and FIG. 5C are schematic diagrams of a backlight source array module with lenses.

FIG. 6A is the schematic diagram of the display device with backlight array real-imaging collocating with the off-axis dual mirror module.

FIG. 6B is another schematic diagram of the display device with backlight array real-imaging collocating with the off-axis dual mirror module.

FIG. 7 is the schematic diagram of the autostereoscopic display device.

FIG. 8A and FIG. 8B are schematic diagrams of correspondence of an eye box array, a left eye position and a right eye position.

FIG. 8C and FIG. 8D are schematic diagrams of correspondence of a plurality of small eye boxes and a single eye position.

FIG. 9 is a schematic diagram of the main display module switching images in an ideal state.

FIG. 10A is a schematic diagram of converting time of liquid crystals.

FIG. 10B is a schematic diagram of pixels of a liquid crystal display panel in a converting state.

FIG. 11A is a schematic diagram of a main display module and a light shield module.

FIG. 11B is the schematic diagram of stacking the main display module and the light shield module.

FIG. 11C is schematic diagrams of response time of IPS liquid crystals and TN liquid crystals.

FIG. 11D, FIG. 11E, FIG. 11F, FIG. 11G, FIG. 11H and FIG. 11I are the detailed schematic diagrams of the stacked structure of the main display module and the light shield module.

FIG. 12A is the schematic diagram of the converting period of the pixels of the main display module.

FIG. 12B is the schematic diagram of the plurality of regions defined in the main display module and the light shield module.

FIG. 13 is the schematic diagram of the switching timing of the plurality of regions of the main display module, the light shield module and the backlight module.

FIG. 14 is the schematic diagram of the switching of each region of the main display module, the light shield module and the backlight module.

FIG. 15 is the schematic diagram of the images respectively seen by the left eye and the right eye in different timing.

FIG. 16A is the schematic diagram of imaging the real image of the backlight module and imaging the virtual image of the main display module.

FIG. 16B and FIG. 16C are the schematic diagram of imaging the partitioning real image of the backlight module and imaging the partitioning virtual image of the main display module.

FIG. 17A, FIG. 17B and FIG. 17C are schematic diagrams of a spatial optical path of a first backlight source collocating with each display region.

FIG. 17D and FIG. 17E are schematic diagrams of the collocation of the first backlight source and the main display module with partitional area, and the intersection of their spatial optical paths.

FIG. 18A, FIG. 18B and FIG. 18C are schematic diagrams of a spatial optical path of a second backlight source collocating with each display region.

FIG. 18D and FIG. 18E are schematic diagrams of the collocation of the second backlight source and the main display module with partitional area, and intersection of their spatial optical paths.

FIG. 19A, FIG. 19B and FIG. 19C are schematic diagrams of a spatial optical path of a third backlight source collocating with each display region.

FIG. 19D and FIG. 19E are schematic diagrams of the collocation of the third backlight source and the main display module with partitional area, and intersection of their spatial optical paths.

FIG. 20A is the schematic diagram of the spatial optical path of the first backlight source collocating with the first display region.

FIG. 20B is the schematic diagram of the spatial optical path of the second backlight source collocating with the second display region.

FIG. 20C is the schematic diagram of the spatial optical path of the third backlight source collocating with the third display region.

FIG. 20D and FIG. 20E are schematic diagrams of the collocation of the backlight source with partitional area and the main display module with partitional area, and intersection of their spatial optical paths.

FIG. 21A is the schematic diagram of the spatial optical path of the third backlight source collocating with the first display region.

FIG. 21B is the schematic diagram of the spatial optical path of the second backlight source collocating with the second display region.

FIG. 21C is the schematic diagram of the spatial optical path of the first backlight source collocating with the third display region.

FIG. 21D and FIG. 21E are schematic diagrams of collocation of the backlight source with partitional area and the main display module with partitional area, and intersection of their spatial optical paths.

FIG. 22A and FIG. 22B are the schematic diagrams of the autostereoscopic display device collocating with an imaging semi-reflective mirror.

FIG. 23A and FIG. 23B are schematic diagrams of an extension eye box array.

FIG. 24A is the exemplary schematic diagram of the main display module, the light shield module and the backlight module.

FIG. 24B and FIG. 24C are the exemplary schematic diagrams of the extension eye box array.

FIG. 25A and FIG. 25B are exemplary schematic diagrams of a small eye box-display region-backlight source matrix table.

FIG. 26A, FIG. 26B, FIG. 26C and FIG. 26D are the exemplary schematic diagrams of the switching timing of a left eye small eye box, a right eye small eye box, the display regions of the main display module, the switch regions of the light shield module and the backlight sources of the backlight module.

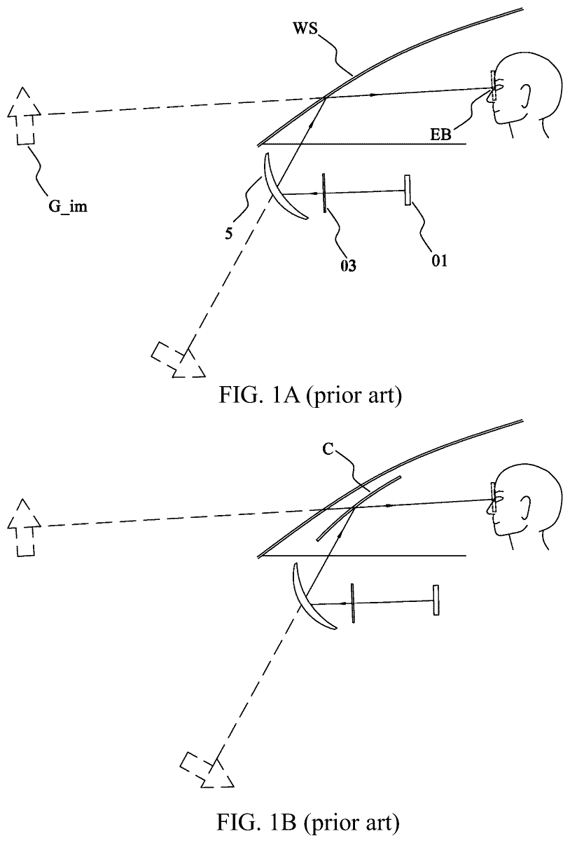

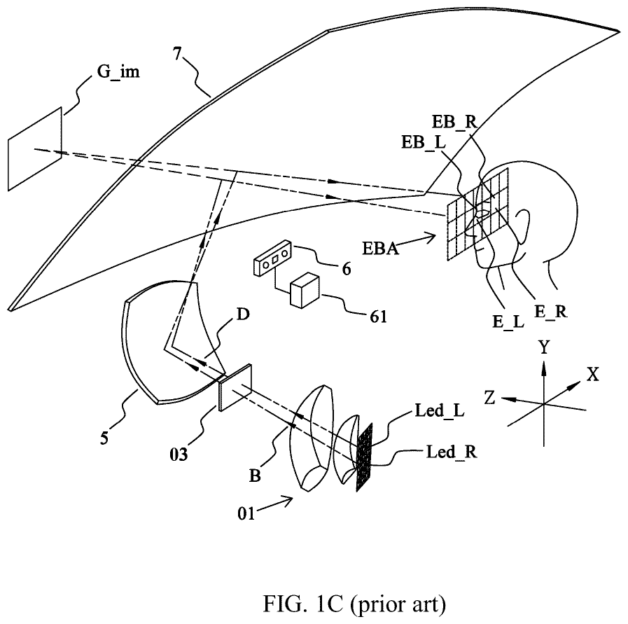

### DETAILED DESCRIPTION

The following explanations related to optical paths would be described by regarding a light emitting direction of a light exit surface as a forward side. However, when the terms “front” and “rear” are used to describe imaging positions, they refer to whether the image is a real image or a virtual image, indicating whether the imaging position is in front of or behind the reflective surface of the curved mirror. These descriptions are provided to conform to the understanding of a person skilled in the art.

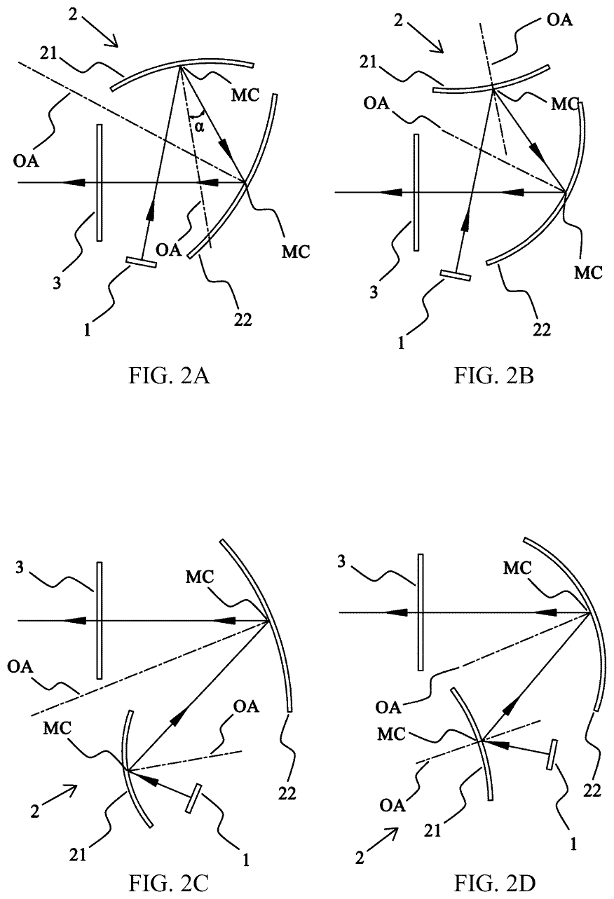

In order to extend the equivalent distance of a backlight source to satisfy the condition of real image imaging that the object distance is greater than the focal length of a concave mirror and to reduce use of space, an off-axis dual mirror module 2 may be utilized to form a directional backlight beam. As shown in FIG. 2A to FIG. 2D, the off-axis dual mirror module includes a first mirror 21 and a second curved mirror 22. The first mirror 21 departs from the optical axis OA of the second curved mirror 22, and the second curved mirror 22 departs from the optical axis OA of the first mirror 21; furthermore, the center of the mirror surface MC of the first mirror 21 is not located on the optical axis OA of the second curved mirror 22, and the center of the curvature of the second curved mirror 22 is not located on the optical axis OA of the first mirror 21. After the light reflected by the backlight module 1 with a less area is reflected by the first mirror 21 and the second curved mirror 22, the virtual image of the backlight source is formed and magnified at a faraway position on the rear of the second curved mirror 22. The position of the virtual image of the backlight source lies outside the focal length of the imaging concave mirror 5, and the real image of the backlight source is formed by the imaging concave mirror 5.

The light emitted by the backlight source of the backlight module 1 projects on the first mirror 21, and reflected by the first mirror 21 to projects on the second curved mirror 22, and the reflected light is reflected and projected on a display 3. In order to form the virtual image of the backlight source far away from the imaging concave mirror 5, the concave mirror may be selected as the second curved mirror 22.

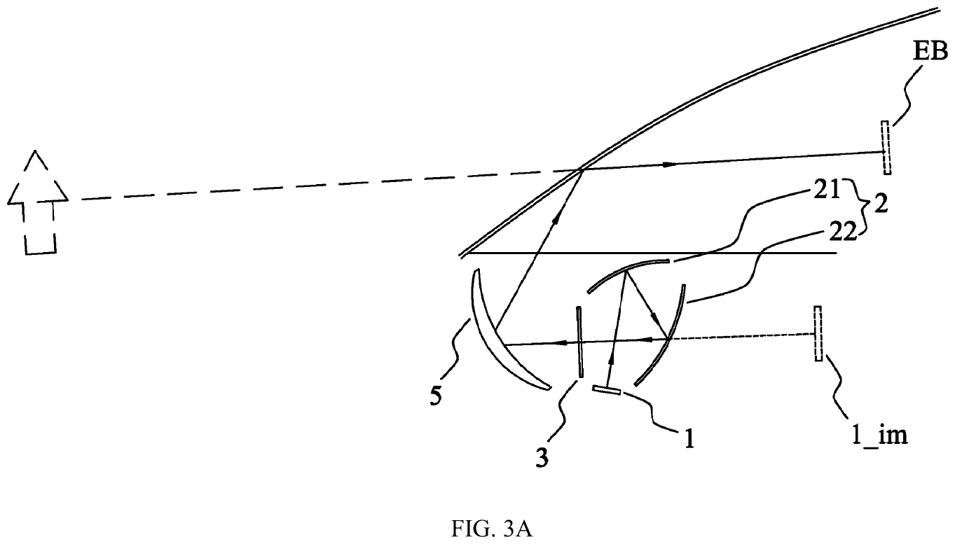

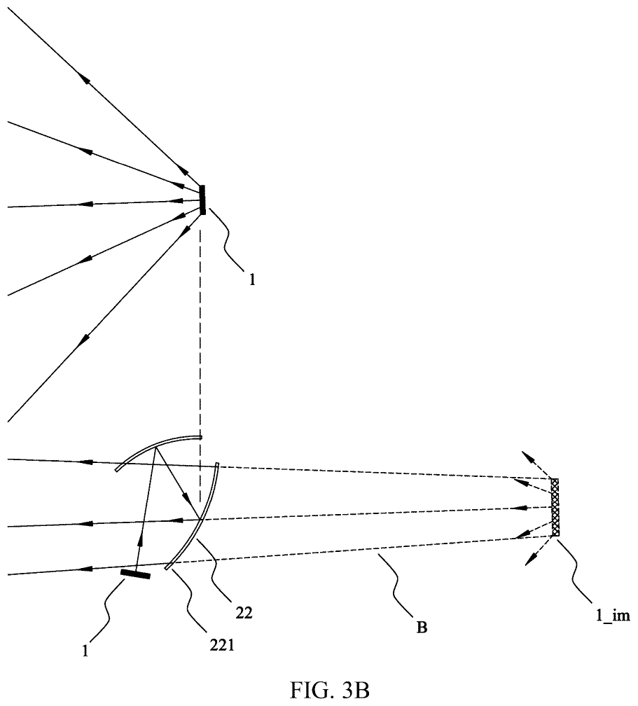

The light from the backlight module 1 is reflected by the first mirror 21, the real image of the backlight source formed in front of the first mirror 21 or the virtual image of the backlight source formed on the rear of the first mirror 21 must be located within the focal length of the second curved mirror 22, and then the second curved mirror 22 can reflect the light to form a virtual image 1_im of the backlight source on the rear of the second curved mirror 22. Thus, as shown in FIG. 2A and FIG. 2C, the first mirror 21 may be a concave mirror; as shown in FIG. 2B and FIG. 2D, the first mirror 21 may be a convex mirror. Or the first mirror 21 may a flat mirror only when the real image of the backlight source or the virtual image of the backlight source can be formed within the focal length of the second curved mirror 22, and then the light is reflected by the second curved mirror 22 to form the virtual image 1_im of the backlight source on the rear of the second curved mirror 22 as shown in FIG. 3A.

A first optical path from the backlight source to the first mirror 21 and a second optical path from the second curved mirror 22 to the display 3 may cross each other as shown in FIG. 2A and FIG. 2B or not cross as shown in FIG. 2C and FIG. 2D.

FIG. 3A shows the display device collocating with the off-axis dual mirror module 2 and the smaller backlight module 1, having advantage of reducing the entire space, and advantage of seeing bright and clear images from the eye box where the real image of the backlight source is formed.

As shown in FIG. 3B, the equivalent backlight source of the display 3 is the virtual image 1_im of the backlight source formed on the rear of the second curved mirror 22, and the diameter of the second curved mirror 22 is less than the beam cross section where the virtual image 1_im of the backlight source diffuses in the second curved mirror 22. In other words, the boundary 221 of the second curved mirror 22 limits the angle of divergence of the beam of the virtual image 1_im of the backlight source, and this is equivalent to form a directional backlight beam.

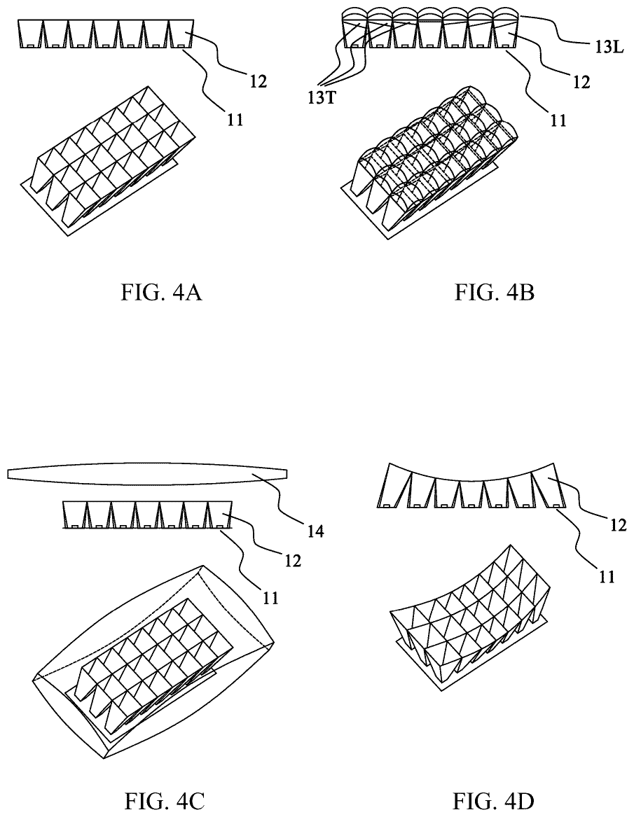

On the design of the backlight module, LEDs may be used as the backlight sources. As shown in FIG. 4A, the LEDs constitute a backlight source array 11, and the backlight source array 11 collocates with a conical reflector array 12. The conical reflector array 12 includes a plurality of conical reflectors, and each of the plurality of conical reflectors may be the hollow reflector of which the surface is coated with a reflective film or a transparent solid light guiding component. The conical reflector array is disposed on the light exit side of the backlight source array 11 to minify the angles of divergence of the light sources and to form the directional backlight beam.

Alternatively, as shown in FIG. 4B, a conical reflector array 12, a deflection lens array 13T and a convergent lens array 13L are sequentially disposed from the light exit side of the backlight source array 11. The deflection lens array 13T is configured to concentrate the angle of projection of each light source, and the convergent lens array 13L further minifies the angles of divergence of the light sources to form the directional backlight beam.

Alternatively, as shown in FIG. 4C, a convergent lens 14 adds to the conical reflector array 12. Alternatively, as shown in FIG. 4D, the tilted conical reflector array 12 includes a plurality of conical reflectors with different tilted angles, and the corresponding tilted angle of each conical reflector increases as each conical reflector goes away from the center of the conical reflector array. The plurality of conical reflectors with the different tilted angles minify the angles of divergence of the light sources and concentrate the angle of projection of each light source.

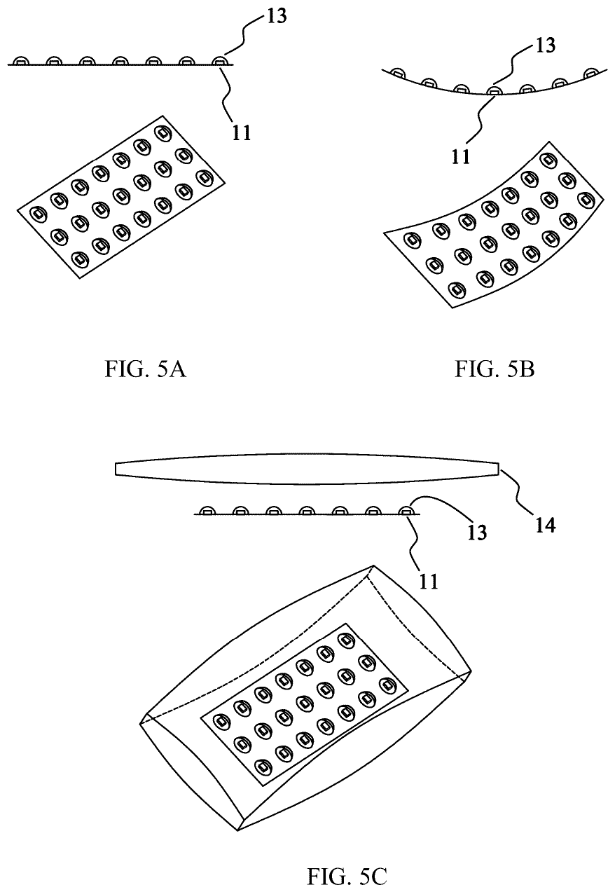

As shown in FIG. 5A, the backlight source array 11 may be set by using the LEDs 13 with lenses on a planar substrate. Alternatively, as shown in FIG. 5B, the backlight source array 11 may be set by using the LEDs 13 with the lenses on a curved substrate. As shown in FIG. 5C, the backlight source array 11 may be set by using the LEDs 13 with lenses on a planar substrate, and the convergent lens 14 is added in front of the backlight source array 11.

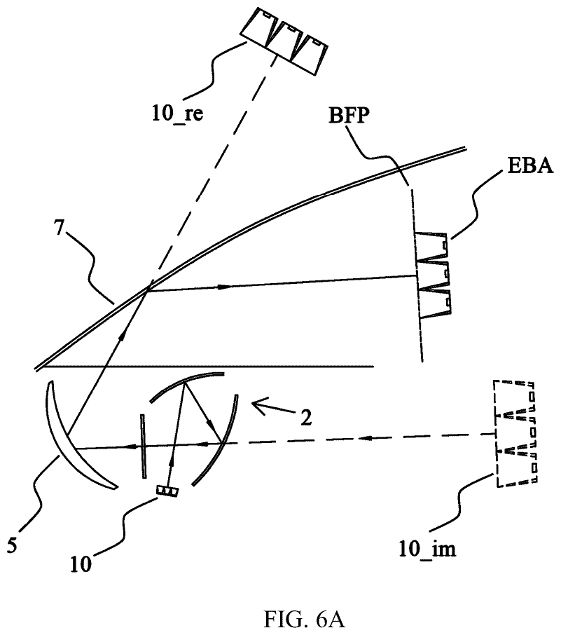

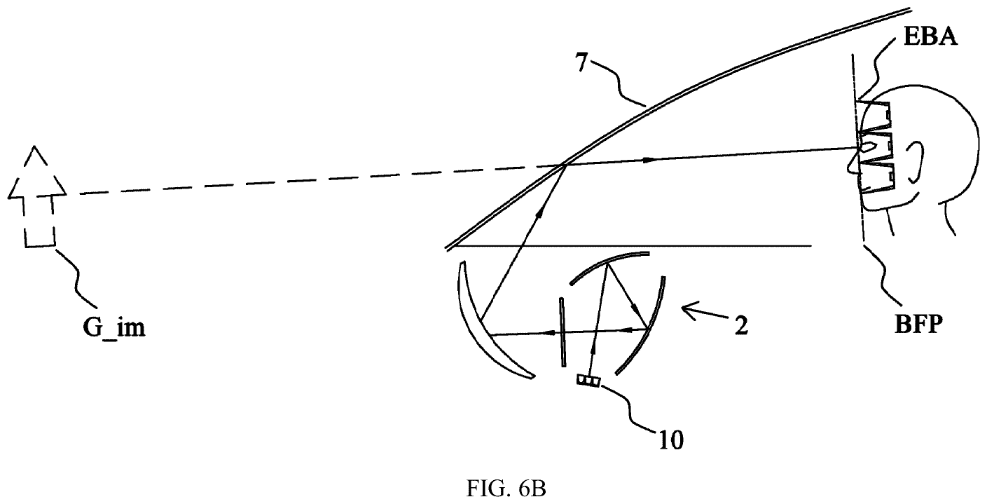

As shown in FIG. 6A, the image (the virtual image 10_im of the backlight source) of the backlight source array 10 of the backlight module by the off-axis dual mirror module 2 is formed outside the focal length of the imaging concave mirror 5, and the reflected backlight beam of the backlight source array from the off-axis dual mirror module 2 is transformed into the real image 10_re of the backlight source by the imaging concave mirror 5. The real image 10_re of the backlight source is projected on an imaging semi-reflective mirror 7 (a windshield) and then is reflected on a backlight focal plane BFP by the imaging semi-reflective mirror 7 (the windshield) to form an eye box array EBA. The backlight source array 10 includes the plurality of backlight sources, and each backlight source forms an independent small eye box EB after passing through the off-axis dual mirror module 2 and the imaging concave mirror 5, and the plurality of small eye boxes EB combine to form the eye box array EBA. As shown in FIG. 6B, the eyes of the viewer inside the eye box array EBA may see the virtual image G_im far away from the viewer through the imaging semi-reflective mirror 7.

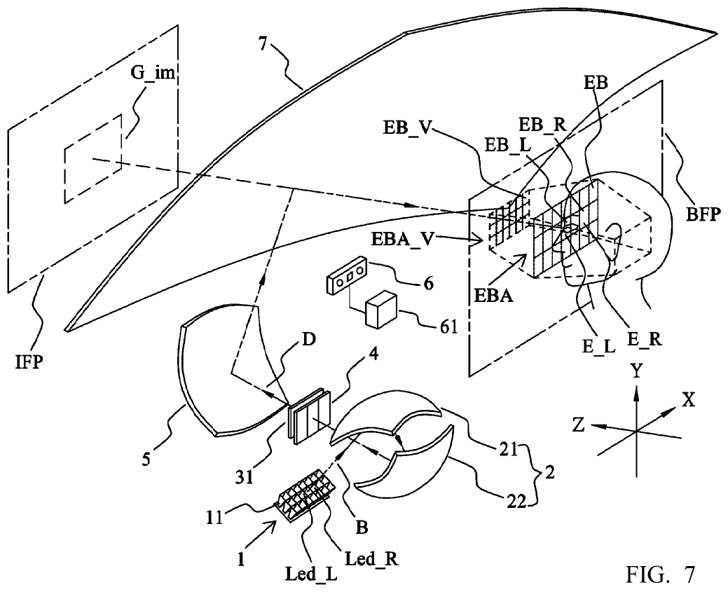

As shown in FIG. 7, an autostereoscopic display device includes a backlight module 1, an off-axis dual mirror module 2, a display 3, an imaging concave mirror 5, an eye tracking module 6. The backlight module 1, the display 3 and the eye tracking module 6 are all connected to the control operation module 61 to transmit detected information and control signals.

The backlight module 1 emits the backlight beam B and include the backlight source array 11 constituted by the plurality of backlight sources.

The off-axis dual mirror module 2 include the first mirror 21 and the second curved mirror 22 to reflect the backlight beam B.

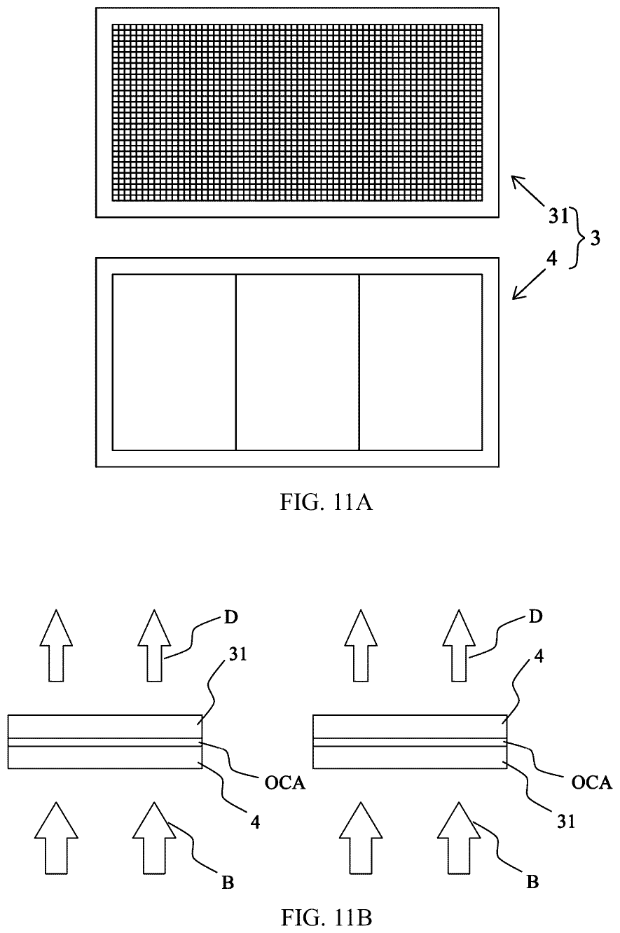

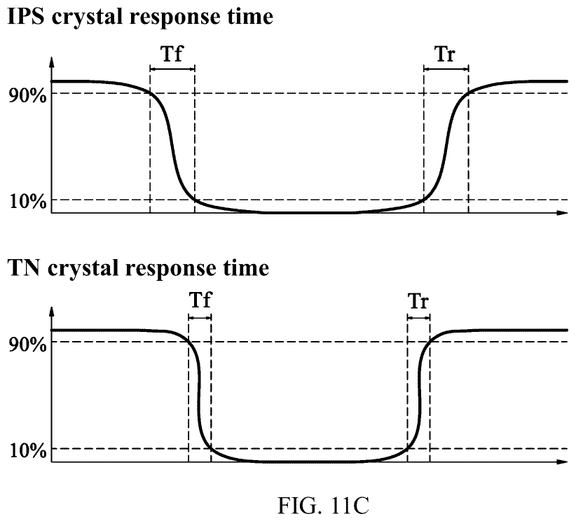

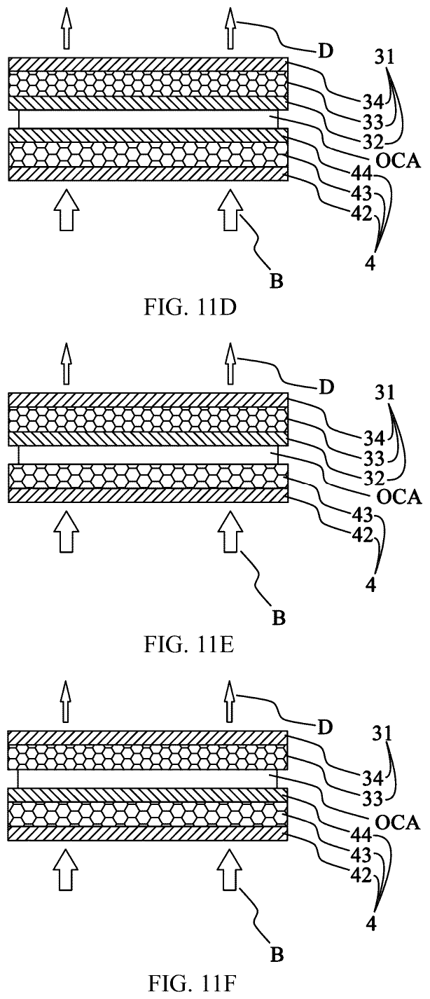

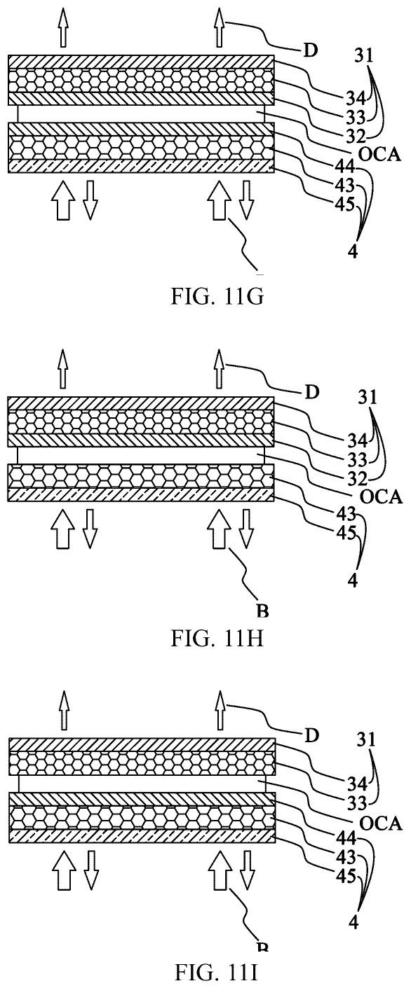

The display 3 (as shown in FIG. 11A) includes a main display module 31 and a light shield module 4 which are stacked upon each other.

The main display module 31 alternately displays a left eye parallax image and a right eye parallax image and defines a plurality of display regions. The light shield module 4 defines a plurality of switch regions, and each of the plurality of switch regions corresponds to one display region to alternately shade the transmission of the light.

The directional backlight beam B passes through the display 3 to form an image beam D.

The imaging concave mirror 5 reflects the image beam D.

The eye tracking module 6 detects relative position information of the left eye, the right eye and the eye tracking module in the space.

The control operation module 61 receives the detection of the eye tracking module 6 and obtains the left eye position E_L and the right eye position E_R of the viewer in the space by distinguishing, calculating, a lookup table or speculating, and the left eye position E_L and the right eye position E_R may be the coordinates of a Cartesian coordinate system, a cylindrical coordinate system, a spherical coordinate system or the other coordinate system. Afterwards, a corresponding left eye small eye box EB_L and the corresponding right eye small eye box EB_R within the eye box array EBA are obtained according to the left eye position E_L and the right eye position E_R, and a left eye backlight source Led_L and a right eye backlight source Led_R are obtained according to the left eye small eye box EB_L and the right eye small eye box EB_R.

The light emitted by the backlight source array 11 of the backlight module 1 is reflected by the off-axis dual mirror module 2, the imaging concave mirror 5 and the imaging semi-reflective mirror 7 and converges on the backlight focal plane BFP on the side of the imaging semi-reflective mirror 7 close to the viewer to form the real image of the backlight source array, i.e., the eye box array EBA including the plurality of small eye boxes EB. The main display module 31 displays the left eye parallax image or the right eye parallax image, the left eye parallax image or the right eye parallax image is reflected by the imaging concave mirror 5 and the imaging semi-reflective mirror 7, and the left eye parallax virtual image G_im or the right eye parallax virtual image G_im is formed on an image focal plane IFP on the side of the imaging semi-reflective mirror 7 far away from the viewer.

When the main display module 31 displays the left eye parallax image, the left eye backlight source Led_L is lit and the light shield module 4 switches each switch region. When main display module 31 displays the right eye parallax virtual image, the right eye backlight source Led_R is lit and the light shield module 4 switches each switch region. The displayed left eye parallax image and the displayed right eye parallax image can be time-divisionally displayed so that the left eye and the right eye can respectively see the bright and clear left eye parallax virtual image G_im and the bright and clear right eye parallax virtual image G_im without afterimages to form stereoscopic vision.

Because the backlight module 1 collocates with the off-axis dual mirror module 2 to form the directional backlight beam, the plurality of small eye boxes EB included within the eye box array EBA are distributed on the backlight focal plane BFP. The effective regions of the plurality of small eye boxes EB extend to the forward depth and the backward depth of the sight direction of the eyes of the viewer, that is, the effective regions of eye box array EBA is extend alone both directions of the z axis, where z axis is perpendicular to both the X-axis (horizontal direction) and the Y-axis (vertical direction). The plurality of different small eye boxes EB may be switched to correspond the current position of the eyes of the viewer, the effective regions of the plurality of small eye boxes EB decrease in size proportionally to their distance from the backlight focal plane BFP along both forward and backward directions of the Z-axis. In addition, by collocating each of the display regions with the at least one backlight source at the different position, another group of small eye boxes EB_V may be defined outside the space of the eye box array EBA on the two sides of the backlight focal plane BFP, the another group of small eye boxes EB_V and the original eye box array EBA collaboratively form an extension eye box array EBA_V with the wider scope. The extension eye box array EBA_V is similar to the combination of two trapezoid 3D structures connected to each other at the (trapezoid) bottom thereof and includes the another group of small eye boxes EB_V and thus can cover the visible movement range of the eyes when the eyes moving upward, downward, left, right, forward and backward to provide the autostereoscopic display device with the wide field of view.

The light shield module 4 switches each switch region according the setting, and each time one or multiple switch regions may be selected to switch, and is configured to shade the display regions where the scenes of the main display module 31 have not been completely converted. The display regions where the scenes of the main display module 31 have not been converted do not display, as a result, afterimages would not be projected. In other words, the left eye and the right eye would still see the images without afterimages and crosstalk to realize high quality autostereoscopic display device.

In addition, the activation time interval of the switch region, the number of the activated switch regions or the time interval of lighting the backlight source may be used to adjust the brightness of the seen images. The more the number of the displayed display regions is or the longer the displaying time of each display region, the higher the brightness of the seen images is.

The eye tracking module 6 may be a camera detector, an ultrasonic detector, a mm Wave radar, a laser detector or the combination thereof and is configured to detect the relative position information of the left eye, the right eye and the eye tracking module. The control operation module 61 receives the relative position information of a left eye, a right eye and the eye tracking module and obtains the left eye position E_L and the right eye position E_R of the viewer in the space by distinguishing, calculating, the lookup table or speculating, and the left eye position E_L and the right eye position E_R may be the coordinates of the Cartesian coordinate system, the cylindrical coordinate system, the spherical coordinate system or the other coordinate system

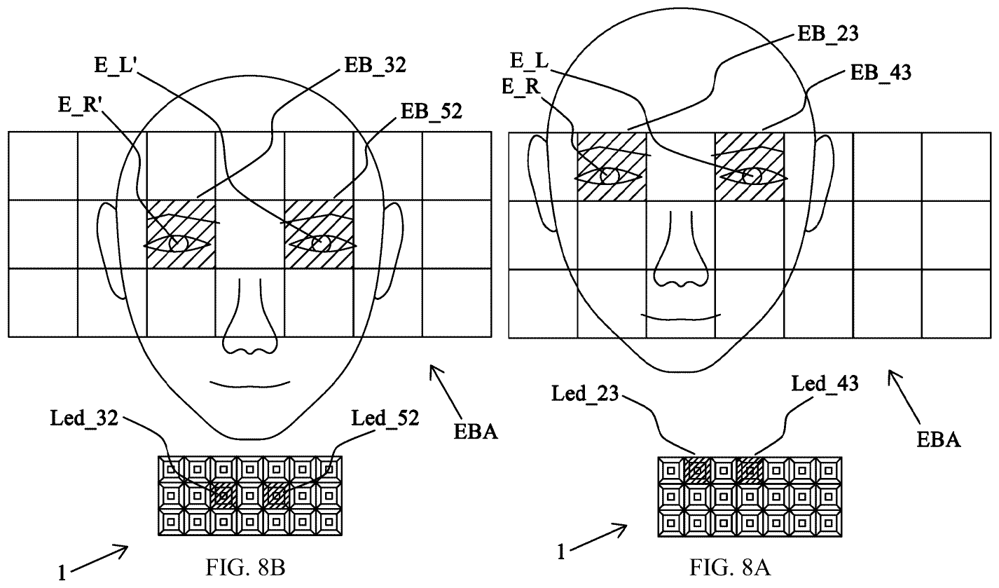

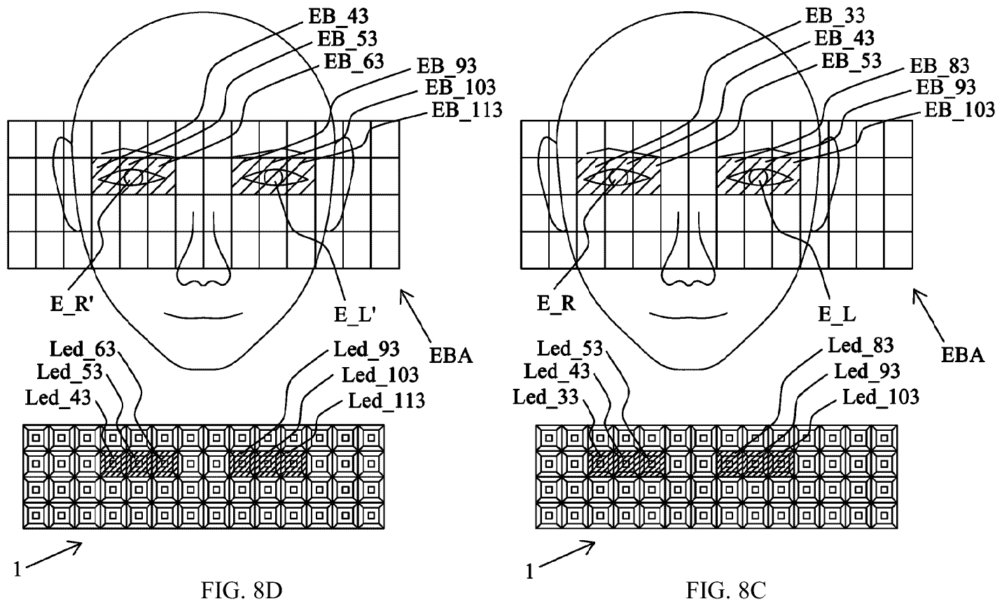

As shown in FIG. 8A, only the eye box array EBA of the backlight focal plane BFP is considered without considering the distribution of the small eye boxes on the z-axis, the eye box array EBA is constituted by the small eye boxes. The control operation module 61 finds the small eye box EB_43 corresponding to the left eye position E_L and the small eye box EB_23 corresponding to the right eye position E_R within the eye box array EBA according to the left eye position E_L and the right eye position E_R. When the main display module 31 displays the left eye parallax image, the backlight source Led_43 corresponding to the small eye box EB_43 is lit. When the main display module 31 displays the right eye parallax image, the backlight source Led_23 corresponding to the small eye box EB_23 is lit.

As shown in FIG. 8B, when the head of the viewer moves, the corresponding backlight sources Led_52 and Led_32 are selected to be lit according to the small eye boxes EB_52 and EB_32 corresponding to the position E_L′ and E_R′ after the movement of the eyes, and the left eye and the right eye would still see the left eye parallax image and the right eye parallax image to form the stereoscopic vision.

As shown in FIG. 8C, one eye may also correspond to adjacent 2n+1 small eye boxes EB within the eye box array EBA, where n>0 and n is a positive integer. For example, one eye corresponds to three (n=1) small eye boxes EB, five (n=2) small eye boxes EB or seven (n=3) small eye boxes EB. Taking adjacent three (n=1) small eye boxes EB as an example, the corresponding central small eye box EB_93 and the small eye box EB_83 and EB_103 on the two sides of the central small eye box EB_93 are selected according to the pupil position of the left eye, and the corresponding central small eye box EB_43 and the small eye box EB_33 and EB_53 on the two sides of the central small eye box EB_43 are selected according to the pupil position of the right eye. When the main display module 31 displays the left eye parallax image, the backlight sources Led_83, Led_93 and Led_103 corresponding to the small eye boxes EB_83, EB_93 and EB_103 are lit. When the main display module 31 displays the right eye parallax image, the backlight sources Led_33, Led_43 and Led_53 corresponding to the small cyc boxes EB_33, EB_43 and EB_53 are lit.

As shown in FIG. 8D, when the pupil of the left eye of the viewer move left to the position of the small eye box EB_103, and the pupil of the right eye of the viewer move left to the position of the small eye box EB_53, three small eye boxes EB_93, EB_103 and EB_113 are reselected according to the pupil position of the left eye, and three small eye boxes EB_43, EB_53 and EB_63 are reselected according to the pupil position of the right eye. Hence, the left eye and the right eye still see the left eye parallax image and the right eye parallax image, and avoid the image interruption resulting from that the adjacent small eye boxes in a transverse direction are too late to switch when the eyes move quickly laterally, thus avoiding image flickering.

The adjacent 2n+1 small eye boxes may be arranged in the left and right (horizontal direction), or arranged in upper and lower direction (vertical direction), the central small eye box is aligned with the pupil of the eye to dynamically switch the small eye boxes, and the adjacent small eye boxes in the left, right, upper, and lower directions serve as tracking buffers when the eyes move.

When human eye sees the object, the image of the object is formed on the retina, and the optic nerve undergoes a stimulus due to the image of the object, takes about 1 ms˜2 ms to convert the stimulus into a nerve impulse and enters the nerve impulse into the brain so that the human perceives the image of the object. But the object is removed, the impression of the optic nerve on the object would not disappear immediately and would continue about 0.1 sec˜0.4 sec, and the characteristic of the optic nerve is called “the persistence of vision of the eye.”

When the converted speed of static scenes is higher than 10 fps˜16 fps (frame per second), the human would perceive that the static scenes are continuous and do not flicker; however, when the scenes are dynamic scenes, the converted speed of the dynamic scenes needs to be 24 fps˜60 fps so that the human would perceive that the dynamic scenes are smooth. Hence, the interval of the image seen by each of the eyes has to be less than 1/24 sec˜ 1/60 sec, i.e., the image interruption time Tg has to be less than 41.67 ms˜16.78 ms. The slower the scenery in the scene moves, the longer the acceptable image interruption time is, and the acceptable image interruption time Tg is near 41.67 ms. The faster the scenery in the scene moves, the shorter the acceptable image interruption time is, and the acceptable image interruption time Tg is near 16.78 ms, and the human would perceive that the images are continuous and do not flicker.

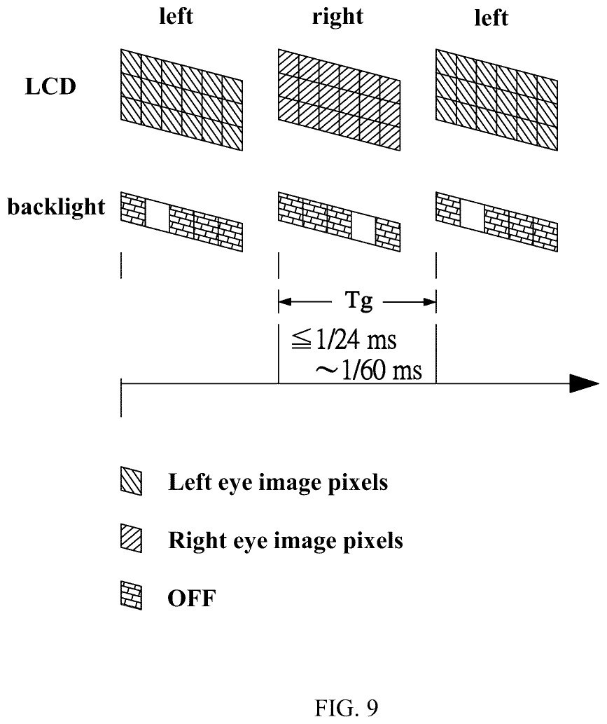

As shown in FIG. 9, when the same liquid crystal display panel is switched to display the left eye image and the right eye image, the image interruption time Tg between the current left eye image and the previous left eye image or the image interruption time Tg between the current right eye image and the previous right eye image has to be less than or equal to 1/24 sec˜ 1/60 sec, i.e., ≤41.67 ms˜16.78 ms.

In an ideal state, when the entire scene of the liquid crystal display panel is completely switched to the left eye image, the backlight source array is switched to the light sources corresponding to the left eye; when the entire scene of the liquid crystal display panel is completely switched to the right eye image, the backlight source array is switched to the light sources corresponding to the right eye, over and over again.

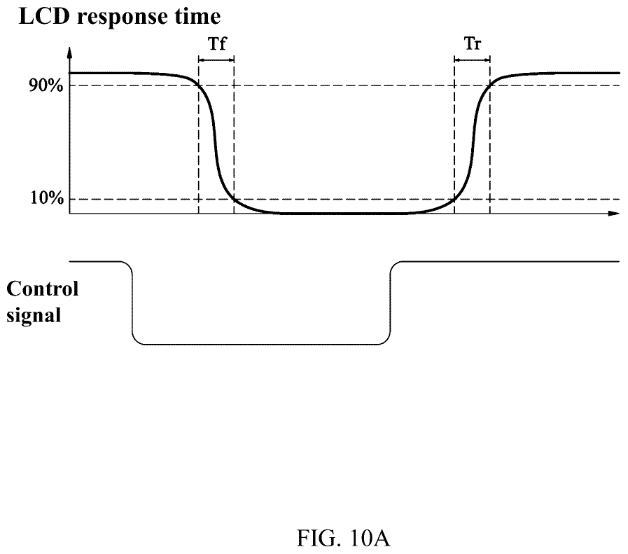

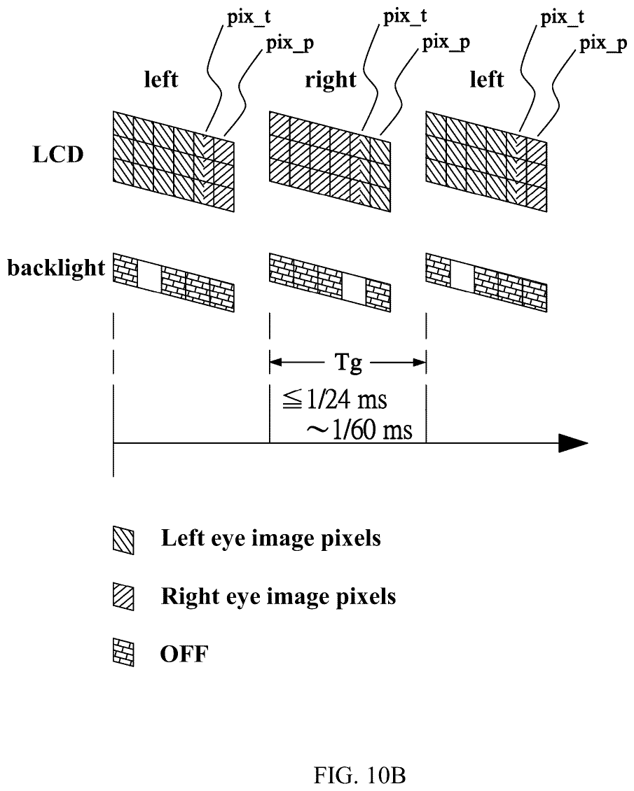

As shown in FIG. 10A, in an actual state, the conversion of the liquid crystals requires time, the response time of the liquid crystals is the sum of rising time Tr and falling time Tf, and the rising time Tr and the falling time Tf are the time interval when the brightness of one pixel increases from 10% to 90% and the time interval when the brightness of one pixel decreases from 90% to 10% respectively. The entire pixels of the scene do not perform the conversion of the liquid crystals synchronously and are sequentially switched by scanning, and there is a converting time difference between the two pixels on the different regions.

As shown in FIG. 10B, in the current automotive grade liquid crystal display panel, within the image interruption time Tg, it is difficult to completely switch all pixels of the entire scene to the image of the another eye, and then, to switch the image of the another eye to the image of the original eye, while also ensuring the backlight beam takes at least 2 ms to pass through the entire liquid crystal display panel, allowing the optic nerve to receive and convert the stimulus into the nerve impulse in order to display the complete image. In the process of switching all pixels of the entire scene to the image of another eye, there are some pixels pix_t in a converting state, and even there are some pixels pix_p in a previous image state.

At this point, when the corresponding backlight sources of the backlight source array are lit, the viewer could see the image including the pixels pix_t in the converting state and the pixels pix_p in the previous image state, i.e., the afterimages and the crosstalk which influence the viewable image quality and may make people dizzy.

As shown in FIG. 11A and FIG. 11B, in order to solve the aforementioned problem, the light incident side or the light exit side of the main display module 31 is stacked with the light shield module 4. In the present embodied aspect, the light shield module 4 is also a display module, and two display modules are attached to each other by an optical clear adhesive (OCA). The backlight beam B needs to pass through the main display module 31 and the light shield module 4 to generate the image beam D.

When the light incident side of the main display module 31 and the light shield module 4 are stacked upon each other, the plurality of switch regions of the light shield module 4 are time-divisionally selected to control the regions of the main display module 31 where the backlight beam B passes through so that the image of the specific display regions forms and projects the image beam D.

When the light exit side of the main display module 31 and the light shield module 4 are stacked upon each other, the plurality of switch regions of the light shield module 4 are time-divisionally selected to control the image beam D to only pass through and to forwardly project on the specific display regions.

For the convenience of explanation, the following would be merely described by the example of the display 3 constituted by stacking the light incident side of the main display module 31 and the light shield module 4 upon each other.

As shown in FIG. 11C, for example, a display panel using in plane switching (IPS) color liquid crystals with wide color gamut is used to be the main display module 31, liquid crystal materials with short response time are used to be the light shield module 4, e.g., a monochrome display panel using twisted nematic (TN) liquid crystals, and the response time (Tr+Tf) of the TN liquid crystals is shorter than the response time of the IPS.

In the detailed stacked structure shown in FIG. 11D, the main display module 31 includes a lower polarizer 32, a liquid crystal layer 33, and an upper polarizer 34, the light shield module 4 includes a lower polarizer 42, a liquid crystal layer 43, and an upper polarizer 44, and the OCA is disposed between the main display module 31 and the light shield module 4. The lower polarizer 32 of the main display module 31 and the upper polarizer 44 of the light shield module 4 are the polarizers with the same polarization direction. When one of the lower polarizer 32 of the main display module 31 and the upper polarizer 44 of the light shield module 4 is removed, the main display module 31 and the light shield module 4 still remains the same function, reducing the optical loss and the cost. As shown in FIG. 11E, the upper polarizer 44 of the light shield module 4 is removed; alternatively, as shown in FIG. 11F, the lower polarizer 32 of the main display module 31 is removed.

In the display system which projects the left eye parallax image and the right eye parallax image, the brightness of the backlight module 1 is distributed by the time due to the switching on timing. Hence, the backlight module 1 with the high brightness is needed. However, about 50% of the backlight beam B projected by the backlight module 1 has different polarization direction from that of the lower polarizer 42 is absorbed by the lower polarizer 42. The remaining approximately 50% of the backlight beam B with the same polarization direction as the lower polarizer 42 enters the liquid crystal layer 43 after passing through the lower polarizer 42. Under the projection of the backlight beam B, the lower polarizer 42 absorbs nearly half of the energy of the backlight beam B so that the temperature on the lower polarizer 42 significantly increases and the increasing temperature on the lower polarizer 42 would easily damage the light shield module 4 and the main display module 31.

In light of the above description, the lower polarizer 42 closest to the light incident side (the display 3) may be replaced with a reflective polarizer 45 so that the light with the polarization direction different from that of lower polarizer 42 is reflected instead of being absorbed by the lower polarizer 42, significantly reducing the temperature of the light shield module 4 and the main display module 31. Hence, the backlight module 1 with the high brightness may be used to enhance the brightness of the displaying while preventing the light shield module 4 and the main display module 31 from being damaged by high temperature. As shown in FIG. 11G, the lower polarizer 42 in FIG. 11D is replaced with the reflective polarizer 45; as shown in FIG. 11H, the lower polarizer 42 in FIG. 11E is replaced with the reflective polarizer 45; as shown in FIG. 11I, the lower polarizer 42 in FIG. 11F is replaced with the reflective polarizer 45.

If the stacking way of the display 3 is that the light exit side of the main display module 31 and the light shield module 4 are stacked upon each other, the lower polarizer 42 closest to the light incident side is replaced with the reflective polarizer 45.

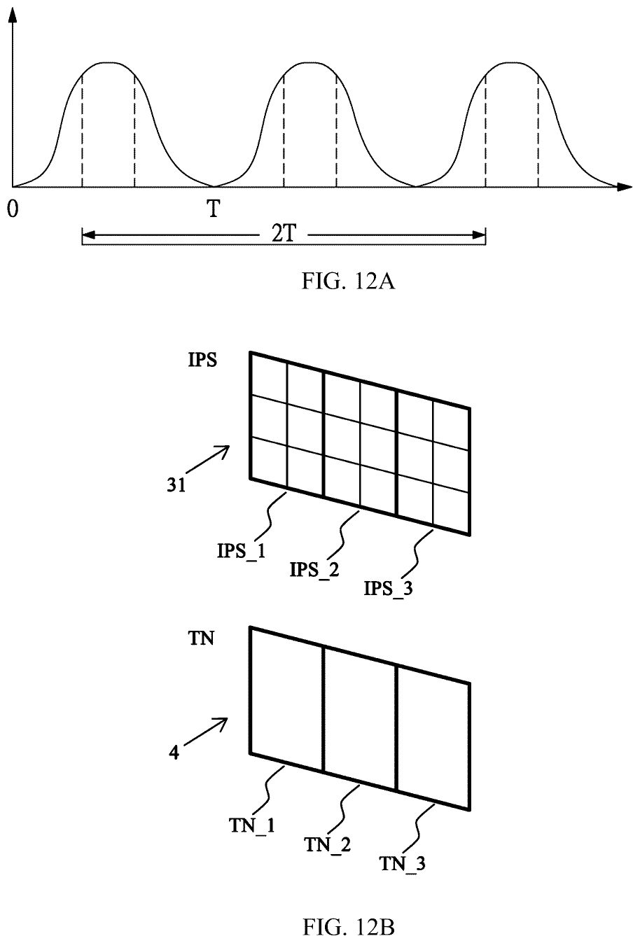

In the curve of the converting period of the liquid crystal polymer of the main display module 31 shown in FIG. 12A, if one complete period of converting the liquid crystal polymer of the module 31 is denoted as T, the time duration between the time point when the image beam projects on the left eye and the time point when the next image beam projects on the left eye is denoted as 2T. As shown in FIG. 12B, the main display module 31 is the color liquid crystal display panel, and for example, three display regions are defined as a first display region IPS_1, a second display region IPS_2, and a third display region IPS_3. Each of the first display region IPS_1, the second display region IPS_2 and the third display region IPS_3 includes a plurality of pixels. When the pixel in the display region is switched to ON to allow the backlight beam to pass through, that pixel in the display region displays its preset color and the preset brightness. When the pixel in the display region is switched to OFF, that pixel in the display region is opaque. The light shield module 4 is the monochrome liquid crystal display panel, and for example, three switch regions with the same size are defined as a first switch region TN_1, a second switch region TN_2, and a third switch region TN_3. The first switch region TN_1 corresponds to the first display region IPS_1, the second switch region TN_2 corresponds to the second display region IPS_2, and the third switch region TN_3 corresponds to the third display region IPS_3. Each of the first switch region TN_1, the second switch region TN_2, and the third switch region TN_3 includes one pixel or the plurality of pixels. When the pixel in the switch region is switched to ON, the backlight beam passes through that pixel in the switch region. When the pixel in the switch region is switched to OFF, that pixel in the switch region is opaque.

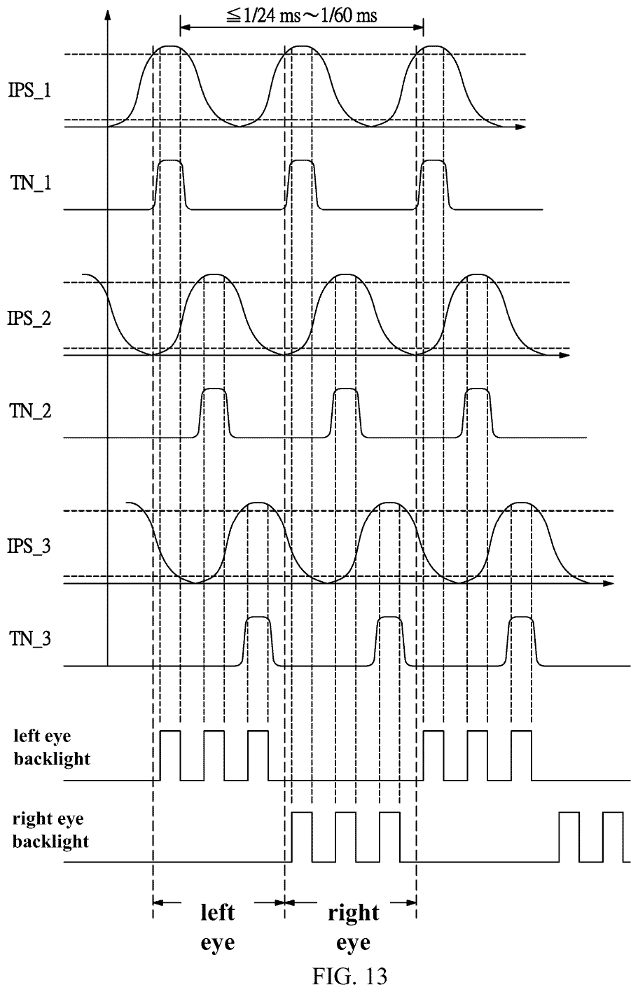

As shown in FIG. 13, the left eye image is displayed first; after the liquid crystals of the first display region IPS_1 are switched to ON, the first switch region TN_1 and the backlight sources corresponding to the left eye are switched to ON; afterwards, the first switch region TN_1 and the backlight sources corresponding to the left eye are switched to OFF, and the liquid crystals of the first display region IPS_1 are switched to OFF.

The timing of the second display region IPS_2 is later than the timing of the first display region IPS_1. The switching timing of the second display region IPS_2, the second switch region TN_2, and the backlight sources corresponding to the left eye is respectively analogous to the switching timing of the first display region IPS_1, the first switch region TN_1, and the backlight sources corresponding to the left eye.

The timing of the third display region IPS_3 is later than the timing of the second display region IPS_2. The switching timing of the third display region IPS_3, the third switch region TN_3, and the backlight sources corresponding to the left eye is respectively analogous to the switching timing of the first display region IPS_1, the first switch region TN_1, and the backlight sources corresponding to the left eye.

When displaying the left eye image is completed and the liquid crystals of the first display region IPS_1 are switched to OFF, the liquid crystals of the first display region IPS_1 are switched from OFF to ON to display the right eye image, then the first switch region TN_1 and the backlight sources corresponding to the right eye are switched to ON; afterwards, the first switch region TN_1 and the backlight sources corresponding to the right eye are switched to OFF, and the liquid crystals of the first display region IPS_1 are switched to OFF.

The liquid crystals of the second display region IPS_2 are switched to OFF and afterwards are switched to ON to display the right eye image. The switching timing of the second display region IPS_2, the second switch region TN_2, and the backlight sources corresponding to the right eye is respectively analogous to the switching timing of the first display region IPS_1, the first switch region TN_1, and the backlight sources corresponding to the right eye.

The liquid crystals of the third display region IPS_3 are switched to OFF and afterwards are switched to ON to display the right eye image. The switching timing of the third display region IPS_3, the third switch region TN_3, and the backlight sources corresponding to the right eye is respectively analogous to the switching timing of the first display region IPS_1, the first switch region TN_1, and the backlight sources corresponding to the right eye.

The switching timing: the first display region IPS_1→the second display region IPS_2→the third display region IPS_3→the first display region IPS_1, and one display region is switched at a time and the display regions are switched in a circular sequence. Or the display regions are switched at a time, and for example, two display regions are switched at a time: the first display region IPS_1& the second display region IPS_2→the second display region IPS_2 & the third display region IPS_3→the third display region IPS_3 & the first display region IPS_1→the first display region IPS_1 & the second display region IPS_2, and so on.

When the image of the display region is in a switching state or/and a not yet switched state (the previous image state), the corresponding backlight sources are turned off or the corresponding switch regions are turned off until switching the image of the display region is complete. When the image switching is complete, the corresponding backlight sources and the corresponding switch regions are turned on again to avoid the afterimages.

In general, the time of turning on the TN switch region is shorter than the time of turning on the IPS display region, and the time of turning on the backlight source is shorter than the time of turning on the TN switch region. For pixels of the IPS display region, the time interval between two times allowing the backlight beam to pass through and project to the same eye needs to be less than the image interruption time Tg (16.78 ms˜41.67 ms), and in other words, the switching time interval of projecting the image beam on the same eye by each display region is less than the image interruption time Tg to meet the time requirements of the persistence of vision of the eye so that the dynamic images are smooth.

The backlight sources would project on the entire display region, and the IPS display regions in the switching state or the not yet switched state (shown the imaging of previous eye) are shaded by the TN switch regions in the OFF state. This prevents the backlight beam from pass through, so that the viewer would not see the afterimages and the crosstalk.

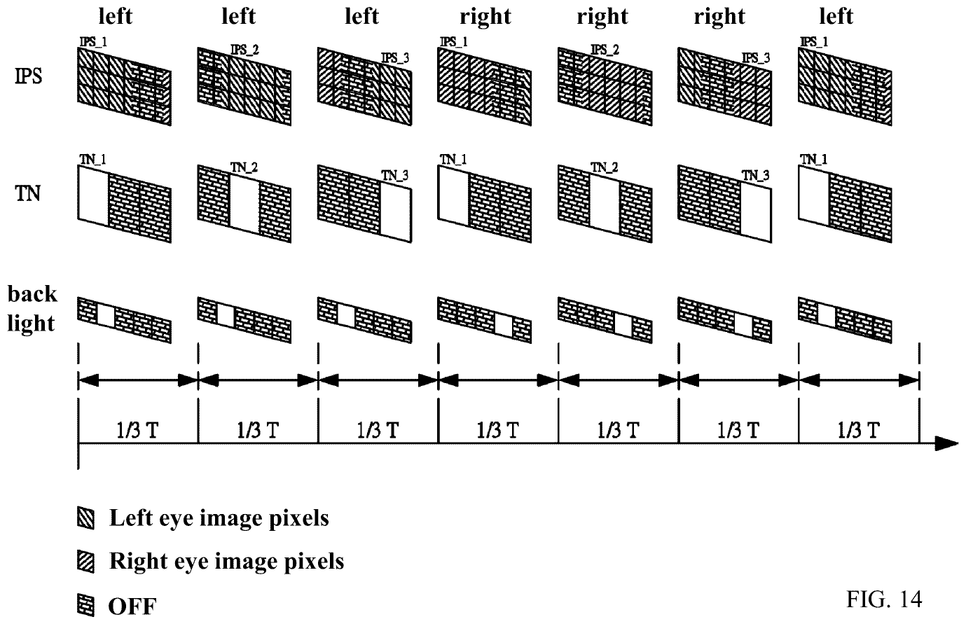

As shown in FIG. 14, during a first ⅓T (=⅙×2T), the first display region IPS_1 has finished the left eye image conversion, and the backlight sources corresponding to the left eye small eye box are lit, but there is the only backlight beam passing through the first switch region TN_1 to pass through the first display region IPS_1. After that, the image beam IPS_1 of the left eye is formed accordingly.

During a second ⅓T (=⅙×2T), the second display region IPS_2 has finished the left eye image conversion, and the backlight sources corresponding to the left eye small eye box are lit, but there is the only backlight beam passing through the second switch region TN_2 to pass through the second display region IPS_2. After that, the image beam IPS_2 of the left eye is formed accordingly.

During a third ⅓T (=⅙×2T), the third display region IPS_3 has finished the left eye image conversion, and the backlight sources corresponding to the left eye small eye box are lit, but there is the only backlight beam passing through the third switch region TN_3 to pass through the third display region IPS_3. After that, the image beam IPS_3 of the left eye is formed accordingly.

During a fourth ⅓T (=⅙×2T), the first display region IPS_1 has finished the right eye image conversion, and the backlight sources corresponding to the right eye small eye box are lit, but there is the only backlight beam passing through the first switch region TN_1 to pass through the first display region IPS_1. After that, the image beam IPS_1 of the right eye is formed accordingly, and so on.

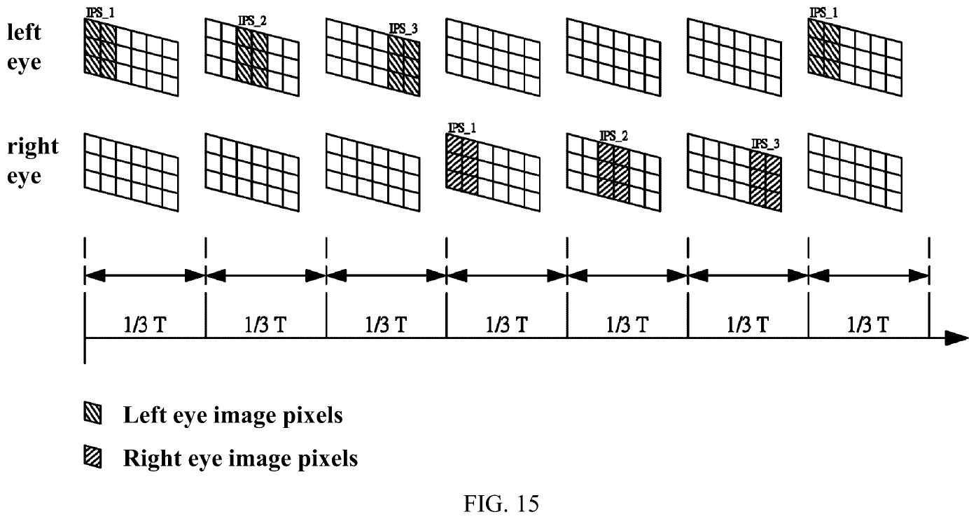

The projection effect of FIG. 14 is demonstrated as FIG. 15.

During the first ⅓T, the image of the first display region IPS_1 is merely projected on the left eye, and there is no image to be projected on the right eye.

During the second ⅓T, the image of the second display region IPS_2 is merely projected on the left eye, and there is no image to be projected on the right eye.

During the third ⅓T, the image of the third display region IPS_3 is merely projected on the left eye, and there is no image to be projected on the right eye.

During the fourth ⅓T, there is no image to be projected on the left eye, and the image of the first display region IPS_1 is merely projected on the right eye.

During the fifth ⅓T, there is no image to be projected on the left eye, and the image of the second display region IPS_2 is merely projected on the right eye.

During the sixth ⅓T, there is no image to be projected on the left eye, and the image of the third display region IPS_3 is merely projected on the right eye

During the seventh ⅓ T, the image of the first display region IPS_1 is merely projected on the left eye, and there is no image to be projected on the right eye. The projection effect of the seventh ⅓ T is the same as the projection effect of the first ⅓T, and so on.

The left eye sequentially sees the left eye images of the first display region IPS_1, the second display region IPS_2, and the third display region IPS_3, and the left eye images of the first display region IPS_1, the second display region IPS_2, and the third display region IPS_3 are combined to form the complete left eye image. After forming the complete left eye image, the left eye images of the first display region IPS_1, the second display region IPS_2, and the third display region IPS_3 are sequentially seen again within 16.78 ms˜41.67 ms. The time interval between the left eye image displayed twice by each of the first display region IPS_1, the second display region IPS_2, and the third display region IPS_3 is less than the time of disappearing the persistence of vision of the eye. Correspondingly, the right eye sequentially sees the right eye images of the first display region IPS_1, the second display region IPS_2, and the third display region IPS_3. The time interval between the right eye image displayed twice by each of the first display region IPS_1, the second display region IPS_2, and the third display region IPS_3 is less than the time of disappearing the persistence of vision of the eye. Both the left eye and the right eye can see continuous and smooth image.

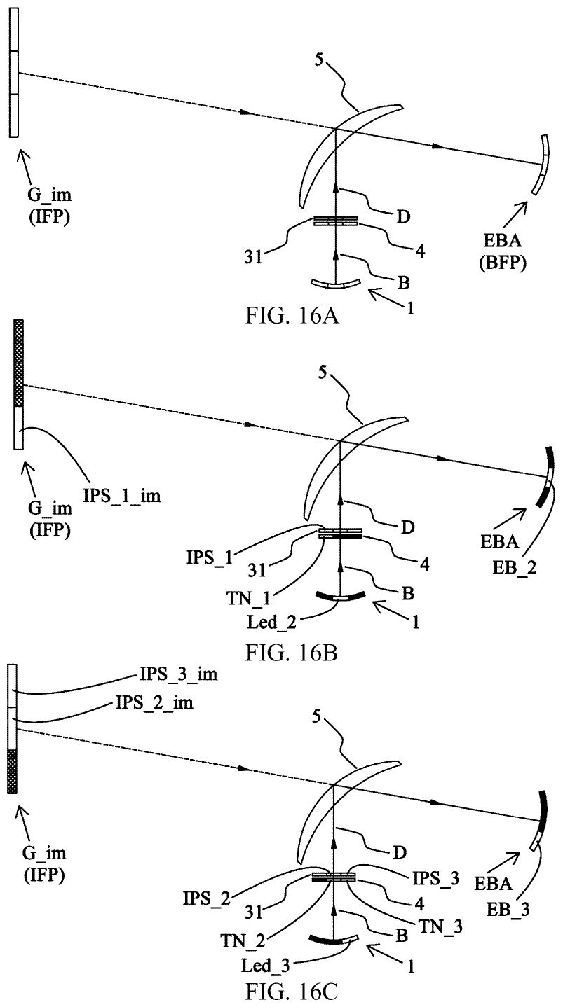

FIG. 16A, FIG. 16B and FIG. 16C are the schematic diagrams of the imaging of the backlight module 1 and the main display module 31. The white region of the backlight module 1 is the region of the lit LED and corresponds to the lit small eye box of the eye box array EBA; the white region of the main display module 31 is the display region switched to ON and corresponds to the parallax virtual image G_im which can be seen on the image focal plane IFP.

As shown in FIG. 16A, the backlight source array of the backlight module 1 generates the backlight beam B, the backlight beam B passes through the light shield module 4 and the main display module 31 to form the image beam D, and the image beam D is reflected by the imaging concave mirror 5. The real image (the eye box array EBA) of the backlight source array is formed on the backlight focal plane BFP in front of the imaging concave mirror 5 by the backlight source array of the backlight module 1, and the parallax virtual image G_im is formed on the rear of the imaging concave mirror 5 by the parallax image of the main display module 31.

As shown in FIG. 16 B, when the second backlight source Led_2 of the backlight module 1 is merely lit, and only the first switch region TN_1 of the light shield module 4 is switched to ON, so that only the second small eye box EB_2 can clearly see the virtual image IPS_1_im of the first display region IPS_1.

As shown in FIG. 16 C, when the third backlight source Led_3 of the backlight module 1 is merely lit, and only the second switch region TN_2 and the third switch region TN_3 of the light shield module 4 are switched to ON, so that only the third small eye box EB_3 can clearly see the virtual image IPS_2_im of the second display region IPS_2 and the virtual image IPS_3_im of the third display region IPS_3.

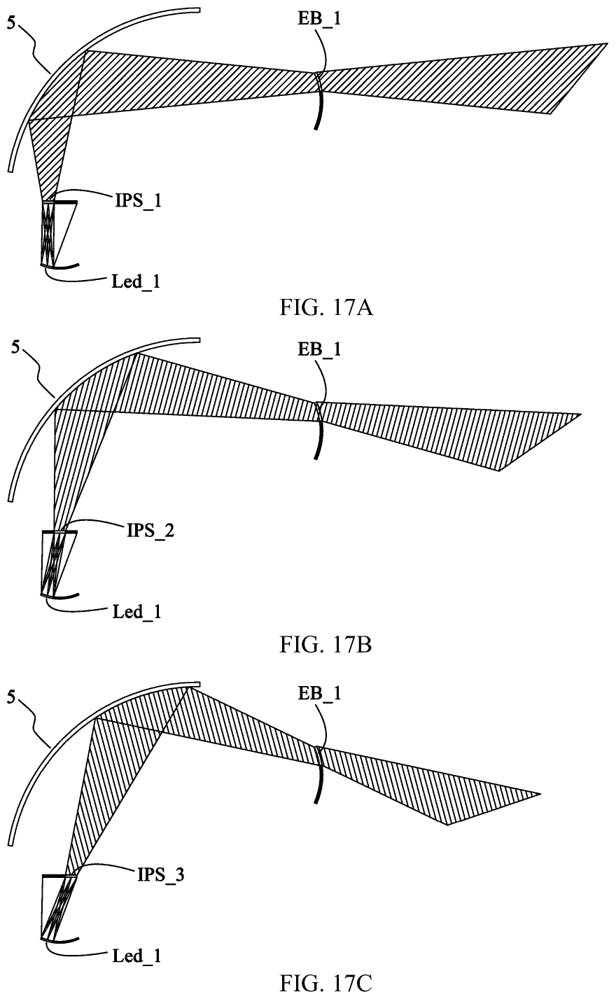

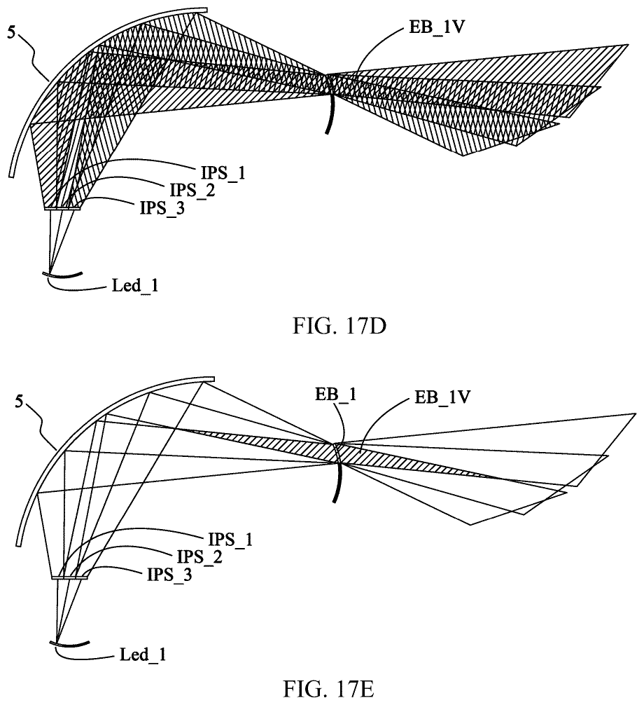

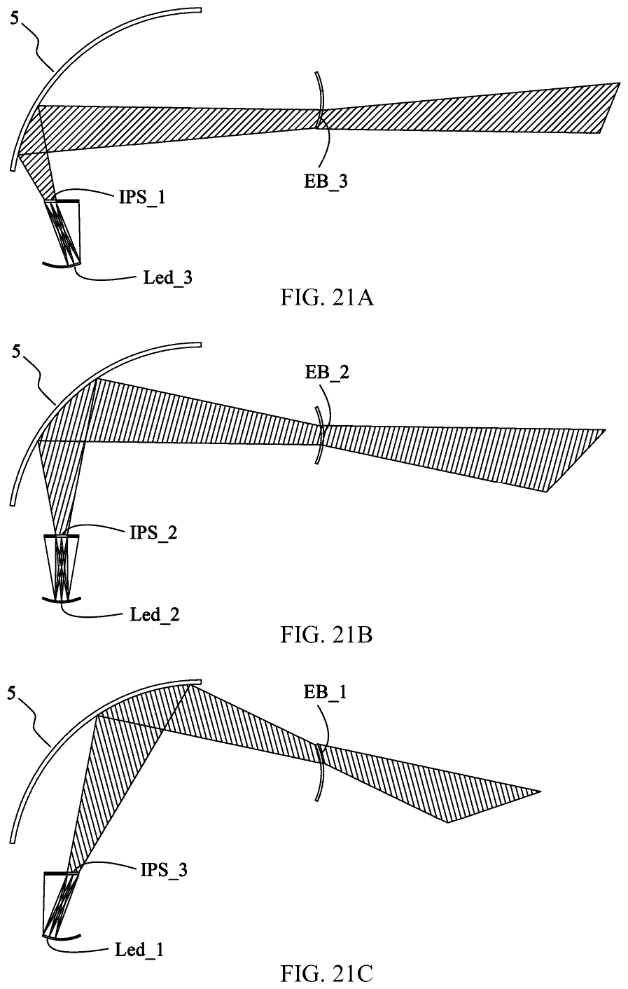

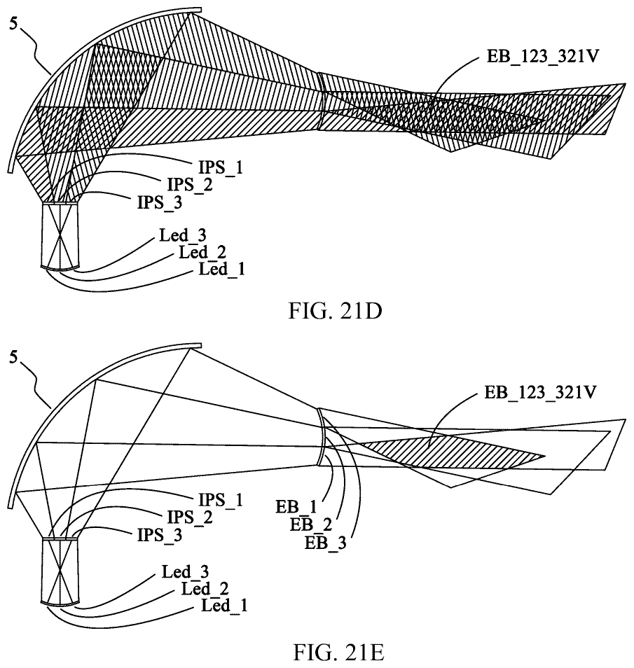

The set of FIG. 17A˜FIG. 21E depict the small eye boxes on the specific positions created by the backlight sources and the display regions. The backlight sources show in the set of FIG. 17A˜FIG. 21E are plane light sources, and the formed real images are the plane real images on the focal plane.

The optical paths shown in FIG. 17A˜FIG. 17C respectively depict the image beams based on the first backlight source Led_1 collocates with the first display region IPS_1, the second display region IPS_2 and the third display region IPS_3 to display, while the first backlight source Led_1 is merely lit. The image beams on these optical paths focus on the first small eye box EB_1.

As shown in FIG. 17D, the optical paths of FIG. 17A˜FIG. 17C are superimposed, and one intersection region may be formed and defined as the small eye box EB_1V. The intersection region is a small eye box in 3D space, which has a volume that gradually shrinks along both the forward direction and the backward direction, such as the small eye box EB_1V at that intersection region of the three slash areas shown in the slash area of FIG. 17E. The combinations of the backlight source and the display regions shown in FIG. 17A˜FIG. 17C are the first display region IPS_1 and the first backlight source Led_1; the second display region IPS_2 and the first backlight source Led_1; the third display region IPS_3 and the first backlight source Led_1. If three combinations collocate and sequentially display, the eyes within the scope of the small eye box EB_1V can see the images of the first display region IPS_1 to the third display region IPS_3, i.e., the eyes can see the complete image.

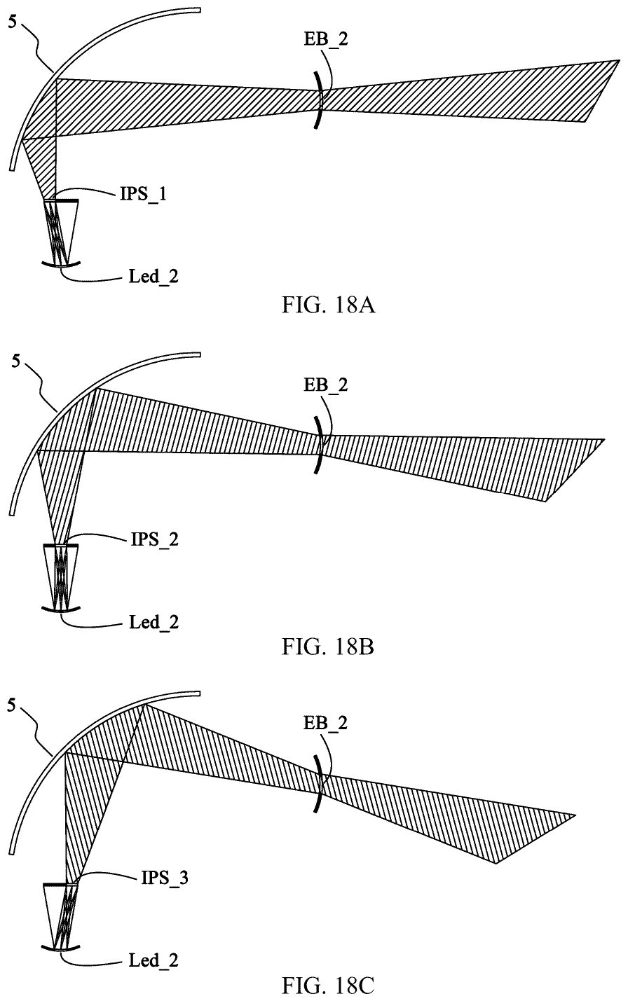

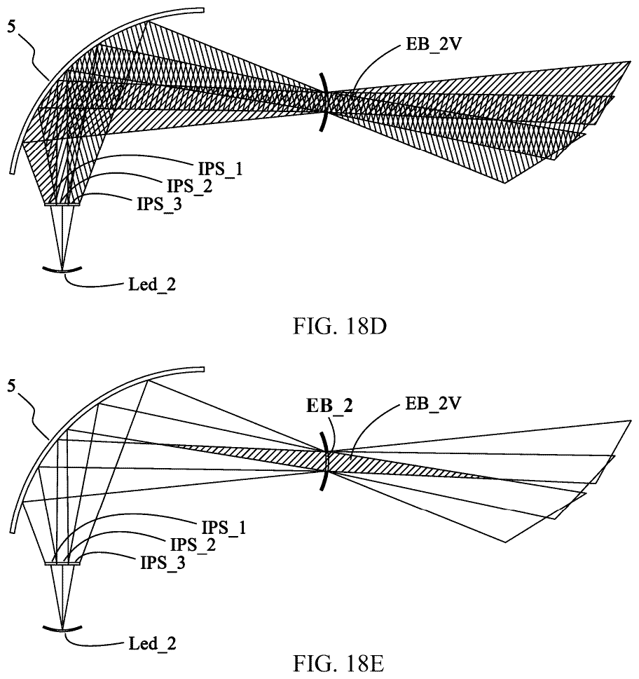

The optical paths shown in FIG. 18A˜FIG. 18C respectively depict the image beams based on the second backlight source Led_2 collocates with the first display region IPS_1, the second display region IPS_2 and the third display region IPS_3 to display, while the second backlight source Led_2 is merely lit. The image beams on these optical paths focus on the second small eye box EB_2.

As shown in FIG. 18D, the optical paths of FIG. 18A˜FIG. 18C are superimposed, and one intersection region may be formed and defined as the small eye box EB_2V, such as the intersection region of the three slash areas shown in the slash area of FIG. 18E. The state of the small eye box EB_2V is similar to the state of the small eye box EB_1V shown in FIG. 17D and FIG. 17E. The combinations of the backlight source and the display regions shown in FIG. 18A˜FIG. 18C are the first display region IPS_1 and the second backlight source Led_2; the second display region IPS_2 and the second backlight source Led_2; the third display region IPS_3 and the second backlight source Led_2. If three combinations collocate and sequentially display, the eyes within the scope of the small eye box EB_2V can see the images of the first display region IPS_1 to the third display region IPS_3, i.e., the eyes can see the complete image.

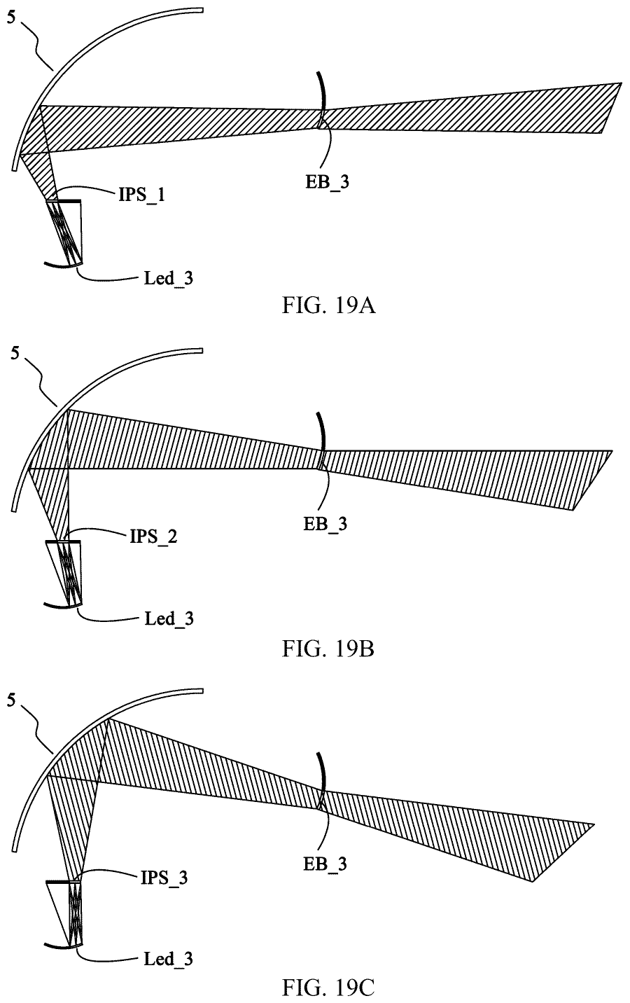

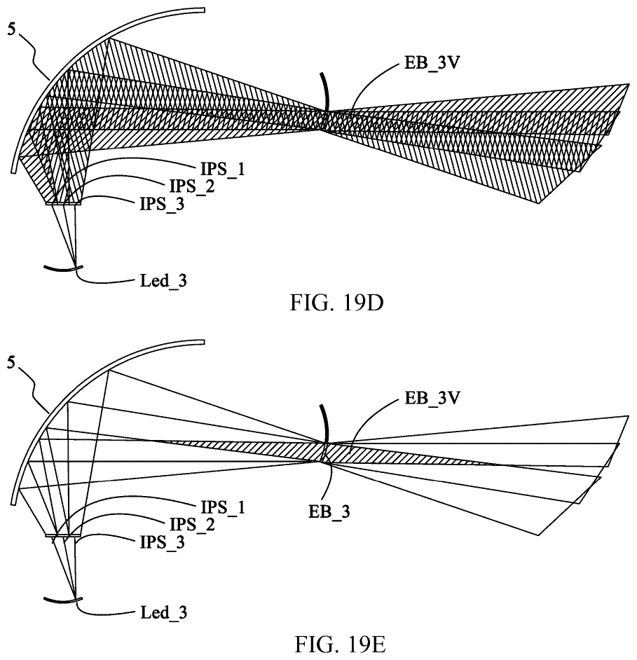

The optical paths shown in FIG. 19A˜FIG. 19C respectively depict the image beams based on the third backlight source Led_3 collocates with the first display region IPS_1, the second display region IPS_2 and the third display region IPS_3 to display, while the third backlight source Led_3 is merely lit. The image beams of these optical paths focus on the third small eye box EB_3.

As shown in FIG. 19D, the optical paths of FIG. 19A˜FIG. 19C are superimposed, and one intersection region may be formed and defined as the small eye box EB_3V, such as the intersection region of the three slash areas shown in the slash area of FIG. 19E. The state of the small eye box EB_3V is similar to the state of the small eye box EB_1V shown in FIG. 17D and FIG. 17E. The combinations of the backlight source and the display regions shown in FIG. 19A˜FIG. 19C are the first display region IPS_1 and the third backlight source Led_3; the second display region IPS_2 and the third backlight source Led_3; the third display region IPS_3 and the third backlight source Led_3. If three combinations collocate and sequentially display, the eyes within the scope of the small eye box EB_3V can see the images of the first display region IPS_1 to the third display region IPS_3, i.e., the eyes can see the complete image.

When the directional backlight beam B is used, the image beams which respectively pass through the first small eye box EB_1, the second small eye box EB_2 and the third small eye box EB_3 are approximately parallel, and correspondingly, the small eye boxes EB_1V, EB_2V and EB_3V would extend more, and the volume of the small eye boxes EB_1V, EB_2V and EB_3V would be greater. Hence, the small eye boxes EB_1V, EB_2V and EB_3V can correspond to the different positions of the eyes in the forward direction and the backward direction, and the viewable region would be wider.

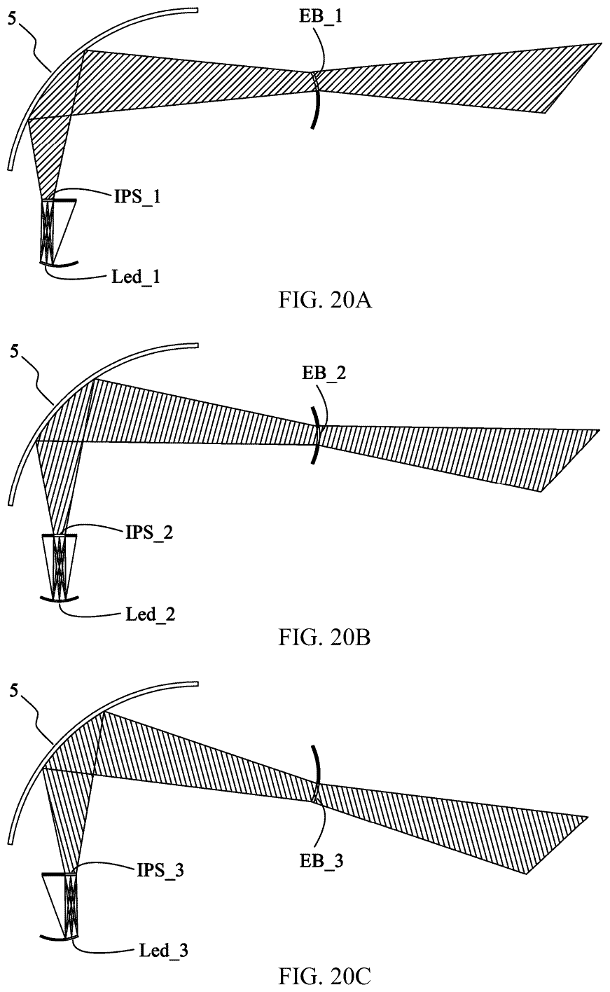

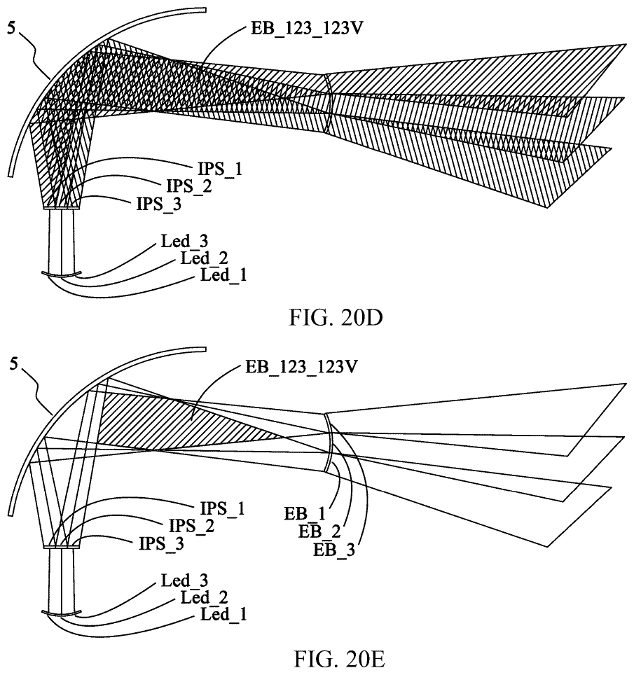

The optical paths shown in FIG. 20A˜FIG. 20C, respectively depict the image beams based on the first backlight source Led_1, the second backlight source Led_2 and the third backlight source Led_3 respectively collocate with the first display region IPS_1, the second display region IPS_2 and the third display region IPS_3. The image beams on these optical paths respectively focus on the first small eye box EB_1, the second small eye box EB_2 and the third small eye box EB_3.

As shown in FIG. 20D, the optical paths of FIG. 20A˜FIG. 20C are superimposed, and one intersection region may be formed and defined as the small eye box EB_123_123V. The intersection region is a small eye box with volume in 3D space and is located between the imaging concave mirror 5, the first small eye box EB_1, the second small eye box EB_2 and the third small eye box EB_3. The volume of the small eye box gradually shrinks along the backward direction, such as the small eye box at that intersection region of the three slash areas shown in the slash area of FIG. 20E. The combinations of the backlight sources and the display regions shown in FIG. 20A˜FIG. 20C are the first display region IPS_1 and the first backlight source Led_1; the second display region IPS_2 and the second backlight source Led_2; the third display region IPS_3 and the third backlight source Led_3. If three combinations collocate and sequentially display, the eyes within the scope of the small eye box EB_123_123V can see the images of the first display region IPS_1 to the third display region IPS_3, i.e., the eyes can see the complete image. Hence, the small eye box EB_123_123V can correspond to the different positions of the eyes in the forward direction and the backward direction, and the viewable region would be wider.

The optical paths shown in FIG. 21A˜FIG. 21C, respectively depict the image beams based on the third backlight source Led_3, the second backlight source Led_2 and the first backlight source Led_1 respectively collocate with the first display region IPS_1, the second display region IPS_2 and the third display region IPS_3. The image beam on these optical paths respectively focus on the third small eye box EB_3, the second small eye box EB_2 and the first small eye box EB_1.

As shown in FIG. 21D, the optical paths of FIG. 21A˜FIG. 21C are superimposed, and one intersection region may be formed and defined as the small eye box EB_321_123V. The intersection region is a small eye box with volume in 3D space and is located on the rear of the first small eye box EB_1, the second small eye box EB_2 and the third small eye box EB_3. The volume of the small eye box gradually shrinks along the forward direction and the backward direction, such as the small eye box EB_321_123V at that intersection region of the three slash areas shown in the slash area of FIG. 21E. With regard to the combinations of the backlight sources and the corresponding display regions shown in FIG. 21A˜FIG. 21C, the eyes within the scope of the small eye box EB_321_123V can see the images of the first display region IPS_1 to the third display region IPS_3, i.e., the eyes can see the complete image. Hence, the small eye box EB_321_123V can correspond to the different positions of the eyes in the forward direction and the backward direction, and the viewable region would be wider.

From FIG. 17A˜FIG. 21E, it can be known that each display region collocates with at least one backlight source at different position, another group of small eye boxes EB_V may be defined outside the space of the eye box array EBA on the two sides of the backlight focal plane BFP, and the another group of small eye boxes EB_V and the original eye box array EBA collaboratively form the extension eye box array EBA_V with the wider scope, i.e., the extension eye box array EBA_V includes a 3D array of more small eye boxes EB_V. The effective regions of the plurality of small eye boxes EB_V elongated along the forward depth and the backward depth of the z-axis, and the image beams may be projected to the small eye boxes EB_V at the different positions by switching the different backlight sources and the different display regions. Even if the position of the eyes leaves the backlight focal plane BFP, the different small eye boxes EB_V will be selected to correspond the movement of the eyes in the upward, downward, left, right, forward and backward directions, and the eyes will see the left eye parallax virtual image or the right eye parallax virtual image when being within the range of the extension eye box array EBA_V in order to provide the autostereoscopic display device with the wide field of view. The adjacent 2n+1 small eye boxes within the extension eye box array EBA_V in the upper and lower direction or in the left and right direction may be used to correspond the left eye or the right eye, and serve as the buffers when the movement of the eyes is tracked.

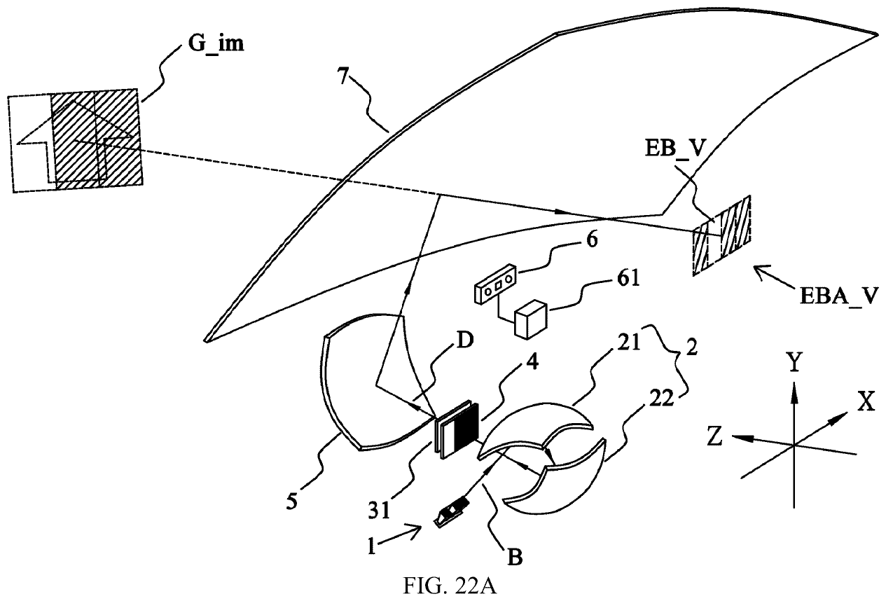

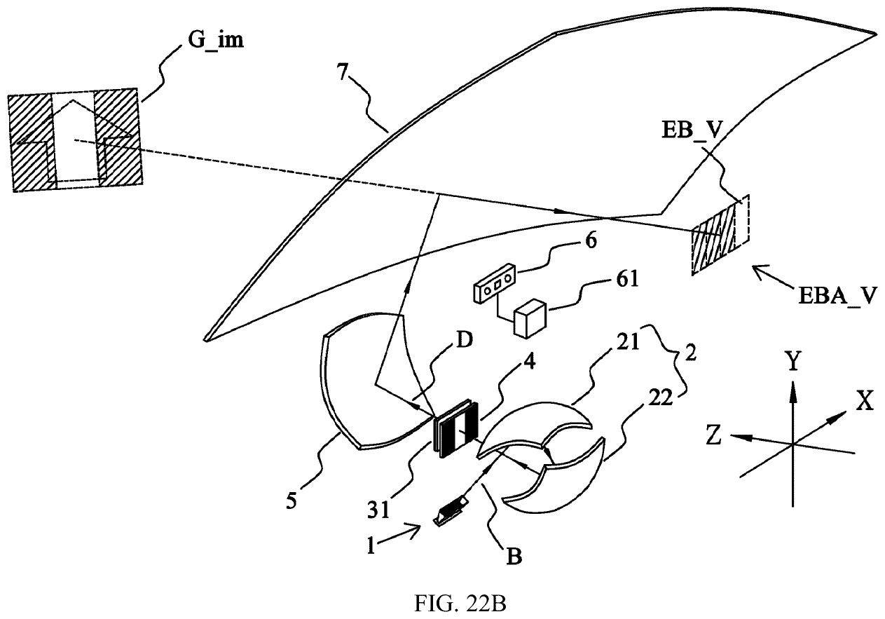

As shown in FIG. 22A and FIG. 22B, by collocating the backlight module 1, the main display module 31, the light shield module 4 with the reflection of the imaging semi-reflective mirror 7 (windshield), the images can be projected on the small eye boxes EB_V of the extension eye box array EBA_V according to the different positions of the eyes of the viewer, and the complete images without the afterimages, the crosstalk and the image interruption can be seen to achieve the autostereoscopic display device with the high quality.

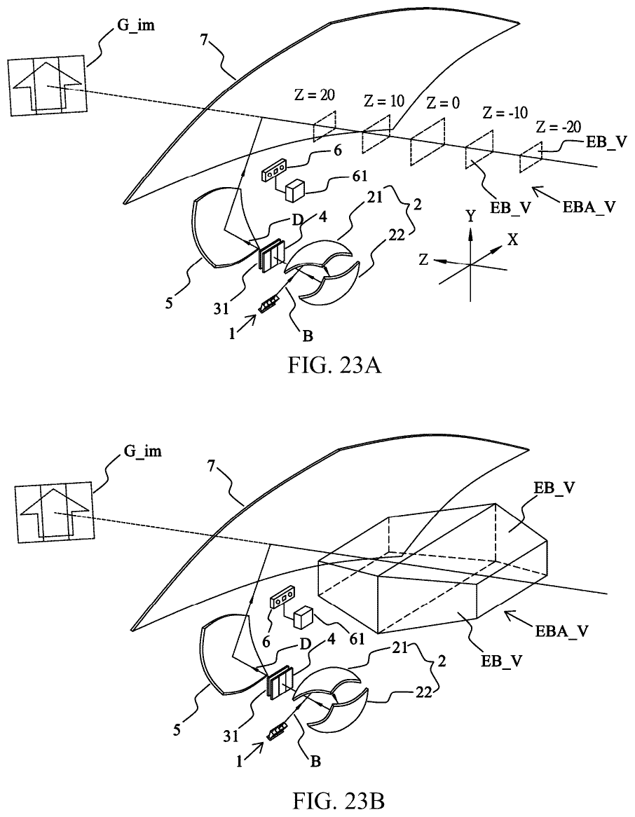

As shown in FIG. 23A and FIG. 23B, the small eye boxes EB_V included in the extension eye box array EBA_V with the wide field of view are not only distributed on the backlight focal plane BFP (XY plane at Z=0) but also include the forward depth and the backward depth of the sight direction of the eyes of the viewer, such as +20 cm from the backlight focal plane BFP and −20 cm from the backlight focal plane BFP (Z=20˜Z=−20), and the distributed area would shrink slightly as away from the backlight focal plane BFP. The extension eye box array EBA_V is similar to the combination of two trapezoid 3D structures connected to each other at the (trapezoid) bottom, covering the visible movement range of the eyes required by the autostereoscopic display device. The relationship between the small eye boxes EB_V at different positions in the extension eye box array EBA_V, the corresponding backlight sources of the backlight module 1 and the display regions of the main display module 31 may be obtained by simulation or actual measurement and serve as a small eye box-display region-backlight source matrix table. For example, the small eye box-display region-backlight source matrix table may be stored at the interior of the control operation module 61 or the interior of the storing device connected to the control operation module 61, enabling lookup and mapping during actual operation.

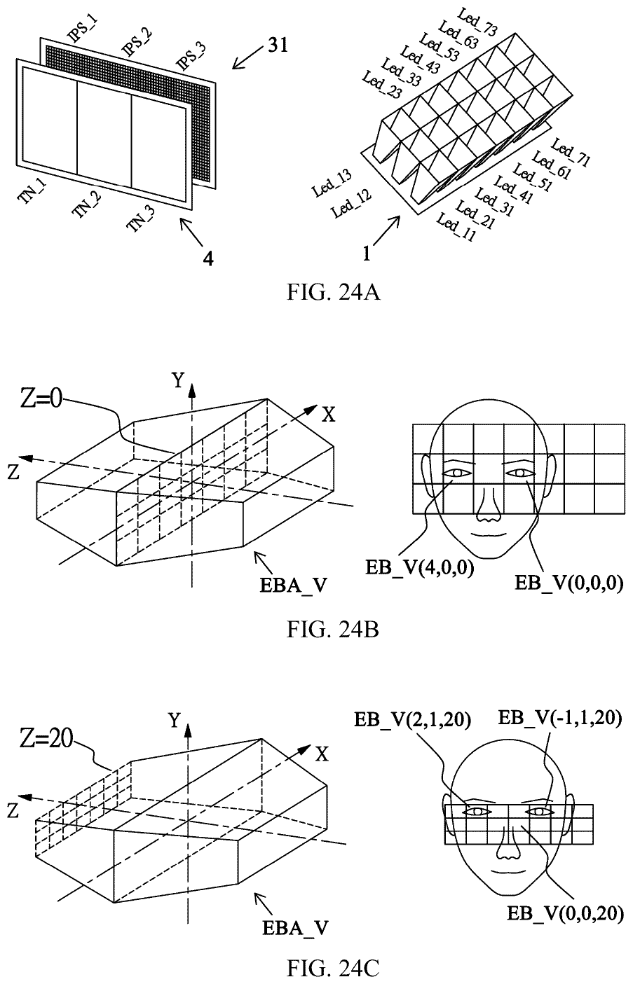

As shown in FIG. 24A, in the present embodied aspect, the backlight module 1 has 7×3 backlight sources (Led_11˜Led_73) which constitute the backlight source array, the light shield module 4 has the first switch region TN_1, the second switch region TN_2, and the third switch region TN_3 arranged in light incident side of the main display module 31, and the main display module 31 has the first display region IPS_1, the second display region IPS_2, and the third display region IPS_3 which respectively correspond to the first switch region TN_1, the second switch region TN_2, and the third switch region TN_3. For example, the distribution of the small eye boxes EB_V of the extension eye box array EBA_V at Z=0 is shown as in FIG. 24B. The eyes of the viewer is located on the plane at Z=0, the left eye corresponds to a small eye box EB_V(0,0,0), and the right eye corresponds to a small eye box EB_V(4,0,0). For example, the distribution of the small eye boxes EB_V of the extension eye box array EBA_V at Z=20 is shown as in FIG. 24C. The eyes of the viewer is located on the plane at Z=20, the left eye corresponds to a small eye box EB_V(−2,−1,20), and the right eye corresponds to a small eye box EB_V(2,−1,20).

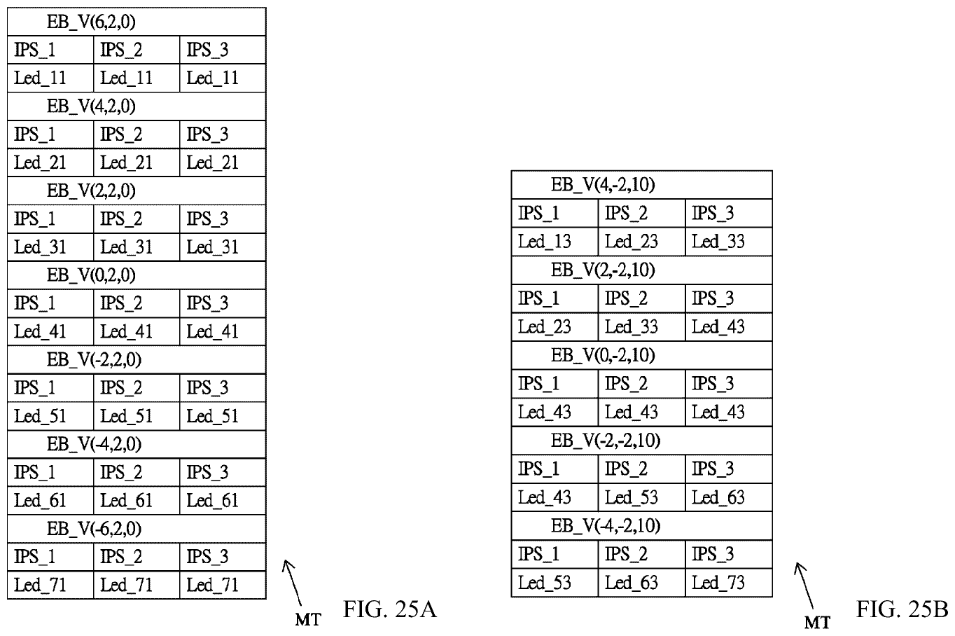

The small eye box-display region-backlight source matrix table may be obtained by the simulation or the actual measurement. For example, one part of the small eye box-display region-backlight source matrix table MT is shown in FIG. 25A and is the matrix table of the small eye boxes (EB_V) at the different positions on the x-axis, when Y=2 and Z=0, the different display regions (IPS) and the corresponding backlight sources (Led). The small eye boxes (EB_V) at the different positions on the x-axis approaches the backlight focal plane (XY plane at Z=0) of the extension eye box array EBA_V, and the backlight sources (Led) of the display regions (IPS) corresponding to the same small eye boxes (EB_V) are the backlight sources with the same position. For example, when the left eye is located on the small eye box EB_V(4,2,0), the left eye matrix is:

$$\begin{matrix}IPS\_ 1 & IPS\_ 2 & IPS\_ 3 \\ Led\_ 21 & Led\_ 21 & Led\_ 21\end{matrix} ,$$

wherein all the first display region IPS_1, the second display region IPS_2, and the third display region IPS_3 correspond to the backlight source Led_21. The content of the aforementioned matrix is: when the image of the first display region IPS_1 is to be projected on the small eye box EB_V(4,2,0), the first switch region TN_1 and the backlight source Led_21 are switched to ON accordingly; when the image of the second display region IPS_2 is to be projected on the small eye box EB_V(4,2,0), the second switch region TN_2 and the backlight source Led_21 are switched to ON accordingly; when the image of the third display region IPS_3 is to be projected on the small eye box EB_V(4,2,0), the third switch region TN_3 and the backlight source Led_21 are switched to ON accordingly.

The other part of the small eye box-display region-backlight source matrix table MT is shown in FIG. 25B and is the matrix table of the small eye boxes (EB_V) at the different positions on the x-axis, when Y=−2 and Z=10, the different display regions (IPS) and the corresponding backlight sources (Led). These small eye boxes (EB_V) at the different positions on the x-axis go away from the backlight focal plane (XY plane at Z=0) of the extension eye box array EBA_V. The backlight sources (Led) corresponding to the display regions (IPS) of the same small eye box (EB_V) may correspond to the same position backlight source, such as the small eye box EB_V(0,−2,10), or may correspond to different position backlight sources, such as the small eye box EB_V(4,−2,10). In details, when the left eye is located on the small eye box EB_V(4,−2,10), the left eye matrix is:

$$\begin{matrix}IPS\_ 1 & IPS\_ 2 & IPS\_ 3 \\ Led\_ 13 & Led\_ 23 & Led\_ 23\end{matrix} ,$$

wherein the first display region IPS_1 corresponds to the backlight source Led_13, the second display region IPS_2 corresponds to the backlight source Led_23, and the third display region IPS_3 correspond to the backlight source Led_33. The content of the aforementioned matrix is: when the image of the first display region IPS_1 is to be projected on the small eye box EB_V(4,−2,10), the first switch region TN_1 and the backlight source Led_13 are switched to ON accordingly; when the image of the second display region IPS_2 is to be projected on the small eye box EB_V(4,−2,10), the second switch region TN_2 and the backlight source Led_23 are switched to ON accordingly; when the image of the third display region IPS_3 is to be projected on the small eye box EB_V(4,−2,10), the third switch region TN_3 and the backlight source Led_33 are switched to ON accordingly.

The control operation module 61 obtains the relative position information of the left eye and the right eye from the eye tracking module 6 to obtain a left eye position coordinate and a right eye position coordinate, and then obtains the corresponding left eye small eye box and the corresponding right eye small eye box according to the left eye position coordinate and the right eye position coordinate. Afterwards, the control operation module 61 obtains the display region-backlight source matrix corresponding to the left eye small eye box and the display region-backlight source matrix corresponding to the right eye small eye box according to the small eye box-display region-backlight source matrix table MT, and selects the corresponding display regions and the corresponding backlight sources for switching. Hence, the left eye of the viewer sees the entire left eye parallax virtual image and the right eye of the viewer sees the entire right eye parallax virtual image to form an autostereoscopic image.

If all switch regions continue to turn on, it is equal to remove the light shield module 4. On the situation, the small eye box-backlight source matrix table is merely used, and each eye may correspond to one small eye box or small eye boxes. The control operation module 61 obtains the relative position information of the left eye and the right eye from the eye tracking module 6, obtains a left eye position coordinate and a right eye position coordinate according to the relative position information of the left eye and the right eye, and obtains the corresponding left eye small eye box and the corresponding right eye small eye box according to the left eye position coordinate and the right eye position coordinate. Afterwards, the control operation module 61 obtains the left eye backlight source corresponding to the left eye small eye box and the right eye backlight source corresponding to the right eye small eye box according to the small eye box-backlight source matrix table MT, and the left eye backlight source and the right eye backlight source are switched based on the display module. Hence, the left eye of the viewer sees the entire left eye parallax virtual image and the right eye of the viewer sees the entire right eye parallax virtual image to form the autostereoscopic image.

If there are only the backlight module 1 and the off-axis dual mirror module 2 on the optical projection path without the light shield module 4, because the beam intersection region when the directional backlight beam pass through the display panel can extend more in the forward direction and the backward direction (similar to FIG. 17, FIG. 18E, FIG. 19E), the complete image can be seen from the intersection region which forwardly and backwardly extends in the z-axis in addition to the region of the small eye box on the focal plane, i.e., the effective region of the small eye box extends in the z-axis. When the eyes move along the z-axis, the eyes can lies within the region of the small eye box. If there are the backlight module 1, the off-axis dual mirror module 2 and the light shield module 4 on the optical projection path, another group of small eye boxes may be defined within the wider scope (as shown in FIG. 20E and FIG. 21E) outside the intersection region of all beams, and the complete image can be seen by the wider scope. In other words, when there are only the backlight module 1 and the off-axis dual mirror module 2 on the optical projection path without the light shield module 4, the range of the eye box array which forwardly and backwardly extends in the z-axis is narrower; when there are the backlight module 1, the off-axis dual mirror module 2 and the light shield module 4 on the optical projection path, the range of the formed extension eye box array which forwardly and backwardly extends in the z-axis is wider.

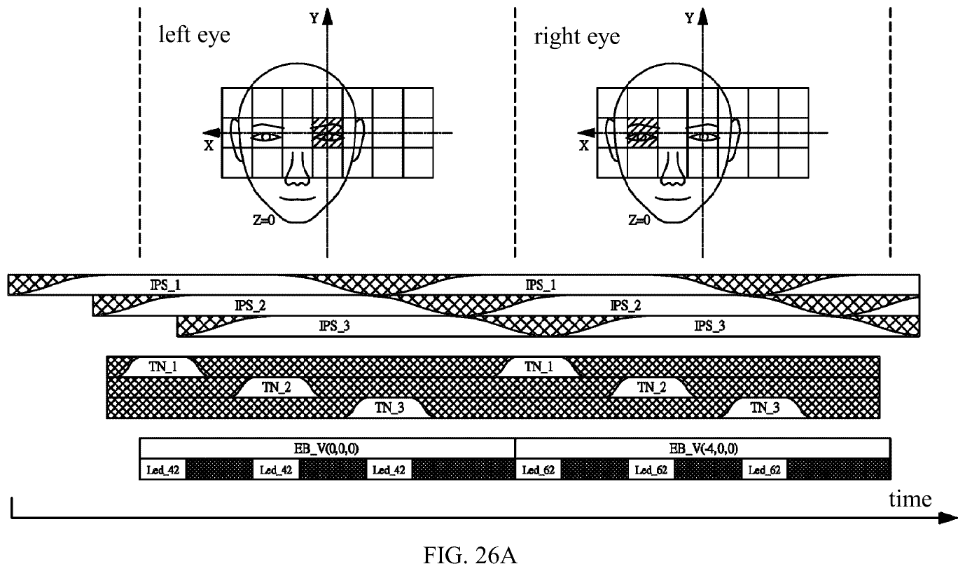

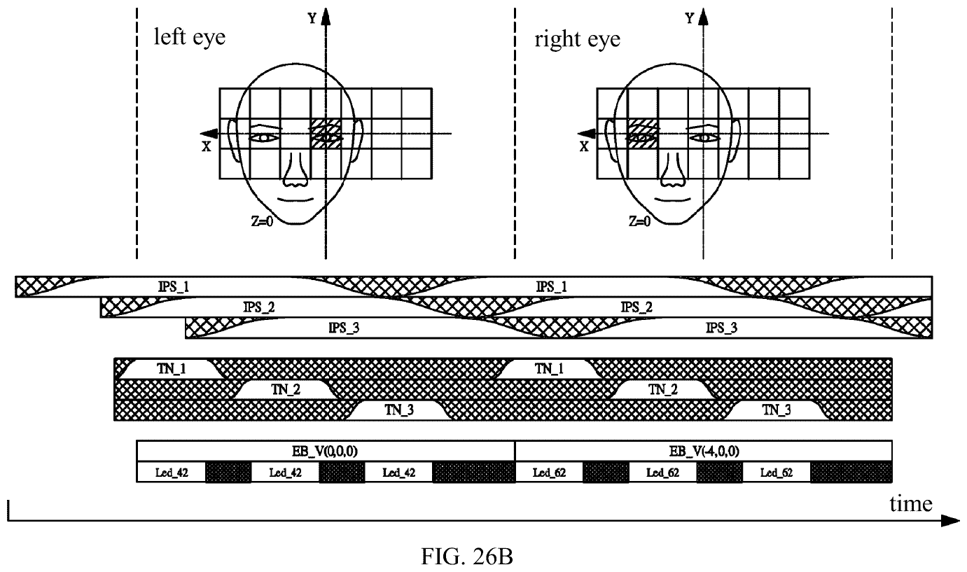

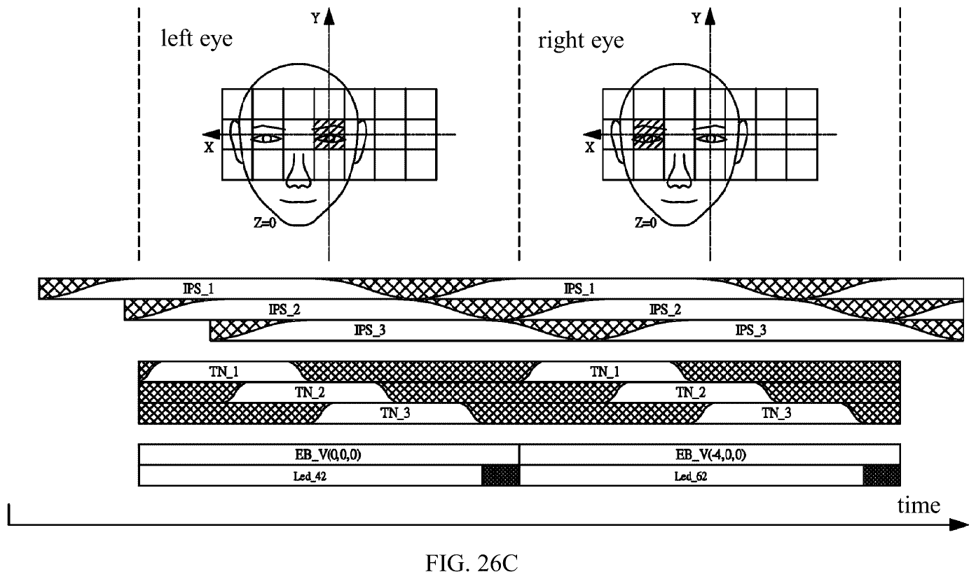

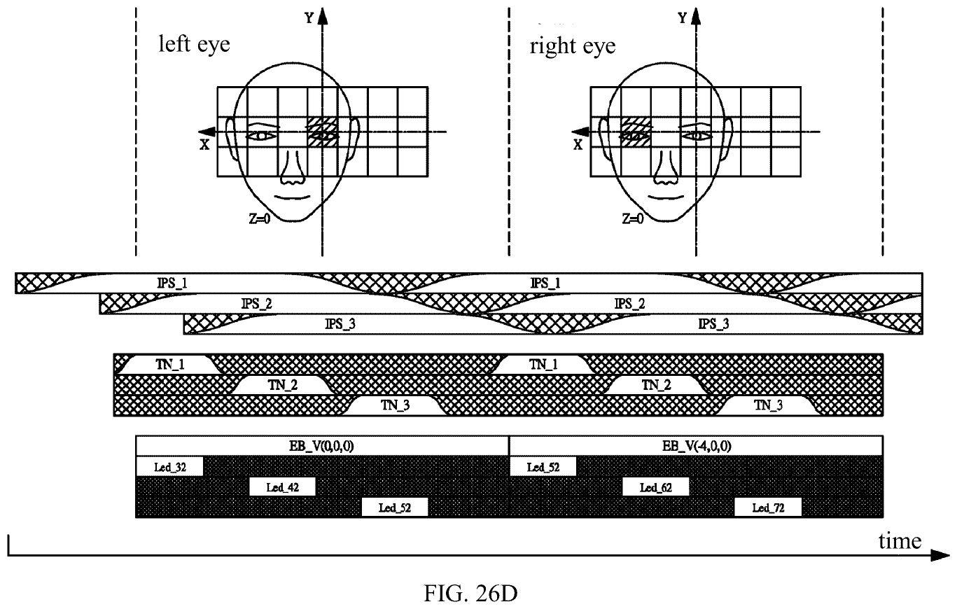

From the timing, the examples of the switching control of the system are shown as in FIG. 26A˜FIG. 26E.

As shown in FIG. 26A, all different display regions, where are corresponding to the left eye, all correspond to the same backlight source Led_42; and all different display regions, where are corresponding to the right eye, correspond to the same backlight source Led_62. In the control timing, the parallax image for the left eye is displayed first, and thus, the first display region IPS_1 is switched to ON. Afterwards, the first switch region TN_1 is also switched to ON, and the backlight source Led_42 is switched to ON. At present, the small eye box EB_V(0,0,0) corresponding to the left eye sees the image of the first display region IPS_1, and then the first display region IPS_1, the backlight source Led_42, and the first switch region TN_1 are switched to OFF according to the opposite timing.

After the image of the first display region IPS_1 starts to be switched to ON, the image of the second display region IPS_2, the second switch region TN_2 and the backlight source Led_42 are sequentially switched to ON. At present, the small eye box EB_V(0,0,0) corresponding to the left eye sees the image of the second display region IPS_2, and then the second display region IPS_2, the backlight source Led_42, and the second switch region TN_2 are switched to OFF according to the opposite timing.

After the image of the second display region IPS_2 starts to be switched to ON, the image of the third display region IPS_3, the third switch region TN_3 and the backlight source Led_42 are sequentially switched to ON. At present, the small eye box EB_V(0,0,0) corresponding to the left eye sees the image of the third display region IPS_3, and then the third display region IPS_3, the backlight source Led_42, and the third switch region TN_3 are switched to OFF according to the opposite timing.

During the time for the left eye of the viewer to see the left eye parallax image, the corresponding switch region would start to be switched to ON after the display region is switched to ON, and the corresponding display region would start to be switched to OFF after the switch region is switched to OFF. Although the backlight source Led_42 illuminates the entire display 3, the switch region would shade the display regions in the converting state or the display regions in the non-displaying state, and the viewer would not see any the afterimages of the display regions in the converting state; only the backlight source Led_42 corresponding to the left eye is lit when the left eye parallax image is displayed, and only the backlight source Led_62 corresponding to the right eye is lit when the right eye parallax image is displayed. Hence, the left eye would not see the right eye parallax image and the right eye would not see the left eye parallax image, i.e., there is no crosstalk. The pass-through time of the backlight beam of each display region is controlled to be the same so that the brightness of the entire image is uniform.

As shown in FIG. 26B, in order to elevate the brightness of the viewed image, the time of switching to ON of the switch region of FIG. 26A and the time of switching to ON of the backlight source of FIG. 26A synchronously extend, and the time of passing through the display region by the backlight beam of the backlight source can increase to elevate the brightness. In other words, the light projection time of the display region changes and the brightness of the image changes. The longer the time of passing through the display region by the backlight beam of the backlight source is, the higher the brightness of the image is. The shorter the time of passing through the display region by the backlight beam of the backlight source is, the lower the brightness of the image is. There is no overlap in the switching time of each switch region, and it may be adapted to the situation that the display regions correspond to the same backlight source and the situation that the display regions correspond to the different backlight sources; the pass-through time of the backlight beam of each display region is controlled to be the same so that the brightness of the entire image is uniform.

As shown in FIG. 26C, when the display regions of the same eye correspond to the same backlight source, in order to elevate the brightness of the viewed image, the time of switching to ON of the switch region may extend more. After the display region is switched to ON, the switch region is switched to ON. Before the display region is switched to OFF, the switch region is switched to OFF. The backlight source would be lit when the first switch region TN_1 is switched to ON and would be turned off until the third switch region TN_3 is switched to OFF; the pass-through time of the backlight beam of each display region is controlled to be the same so that the brightness of the entire image is uniform.

As shown in FIG. 26D, when the display regions of the same eye correspond to the different backlight sources, each backlight source is switched to ON at the entire time slot when the corresponding switch region is switched to ON, or each backlight source is switched to ON at the partial time slot when the corresponding switch region is switched to ON in order to change the brightness of the image. The longer the time of passing through the display region by the backlight beam of the backlight source is, the higher the brightness of the image is. The shorter the time of passing through the display region by the backlight beam of the backlight source is, the lower the brightness of the image is. The pass-through time of the backlight beam of each display region is controlled to be the same so that the brightness of the entire image is uniform.

Thus, the problem about the afterimages and the crosstalk of the autostereoscopic display device can be effectively solved, and the autostereoscopic display device of the present disclosure would not easily cause the viewer to be dizzy and elevate the image quality.

In light of the aforementioned technical features, the problem which the current autostereoscopic display device faces may be improved. In the autostereoscopic display device of the present disclosure, the afterimages and the crosstalk are eliminated, the brightness of the image is elevated, the brightness of the scene is uniform, the flicker images are avoided, and the viewable region would be wider. These advantages make the present disclosure the most suitable autostereoscopic display device for the mobile vehicles, such as car, ships, aircraft, etc.

### LIST OF REFERENCE SIGNS

### Prior Art

01: backlight source
03: display panel
5: imaging concave mirror
6: eye tracking module
61: control operation module
7: imaging semi-reflective mirror
G_im: virtual image
B: directional backlight beam
D: directional image beam
EB: eye box
EBA: eye box array
WS: windshield
C: combiner
E_L,E_R: eye position
EB_L: left eye small eye box
EB_R: right eye small eye box
[this application]
1: backlight module
1_im: virtual image of the backlight source
10, 11: backlight source array
10_im: virtual image of the backlight source
10_re: real image of the backlight source
12: conical reflector array
13: LED
13T: deflection lens array
13L: convergent lens array
14: convergent lens
2: off-axis dual mirror module
21: first mirror
22: second curved mirror
221: boundary
3: display
31: main display module
32: lower polarizer
33: liquid crystal layer
34: upper polarizer
4: light shield module
42: lower polarizer
43: liquid crystal layer
44: upper polarizer
45: reflective polarizer
5: imaging concave mirror
6: eye tracking module
61: control operation module
7: imaging semi-reflective mirror
B: backlight beam
BFP: backlight focal plane
D: image beam
EB, EB_1, EB_2, EB_3, EB_11˜EB144, EB_V: small eye box
EB_1V, EB_2V, EB_3V, EB_123_123V, EB_321_123V, EB_L, EB_R: small eye box
EB_L, EB_R: small eye box
EBA: eye box array
EBA_V: extension eye box array
E_L, E_L′: left eye position
E_R, E_R′: right eye position
G_im: virtual image
IFP: image focal plane
IPS_1, IPS_2, IPS_3: display region
IPS_1_im, IPS_2_im, IPS_3_im: virtual image
Led_1, Led_2, Led_3, Led_11˜Led144: backlight source
Led_L, Led_R: backlight source
MC: center of the mirror surface
MT: small eye box-display region-backlight source matrix table
OA: optical axis
OCA: optical clear adhesive
pix_p: pixel
pix_t: pixel
TN_1, TN_2, TN_3: switch region

What is claimed is:

1. An autostereoscopic display device with partitioning backlight adapted to an imaging semi-reflective mirror, the autostereoscopic display device with partitioning images comprising:
a backlight module emitting a directional backlight beam and comprising a backlight source array constituted by a plurality of backlight sources;
a display comprising a main display module and a light shield module which are stacked upon each other, wherein the main display module alternately displays a left eye parallax image and a right eye parallax image, and the directional backlight beam passes through the display to form an image beam;
an imaging concave mirror reflecting the image beam;
wherein the main display module defines a plurality of display regions, the light shield module defines a plurality of switch regions, and each of the plurality of switch regions corresponds to the one display region; when the main display module displays an image, at least one of the plurality of switch regions is time-divisionally selected to control at least one display region to time-divisionally project the image beam, and the others of the plurality of switch regions shade the corresponding display regions in the main display module which are in a switching state or a not yet switched state;
wherein, an equivalent distance between the backlight source array and the imaging concave mirror is greater than a focal length of the imaging concave mirror, the directional backlight beam is reflected by the imaging concave mirror and the imaging semi-reflective mirror, the reflected directional backlight beam projects and converges on a backlight focal plane to form a real image of the backlight source array, each of the plurality of backlight sources forms an independent small eye box, and the plurality of small eye boxes constitutes the real image of the backlight source array and defines an eye box array.

2. The autostereoscopic display device with partitioning backlight according to claim 1, wherein an equivalent distance between the main display module and the imaging concave mirror is less than the focal length of the imaging concave mirror, and according to the left eye parallax image and the right eye parallax image, a left eye parallax virtual image and a right eye parallax virtual image are formed on one side of the imaging semi-reflective mirror far away from the eye box array.

3. The autostereoscopic display device with partitioning backlight according to claim 1, wherein an effective region of each of the small eye boxes extends on two sides of the backlight focal plane, and the small eye box shrinks along a forward direction and a backward direction of the backlight focal plane.

4. The autostereoscopic display device with partitioning backlight according to claim 1, wherein when the main display module displays a left eye parallax image or a right eye parallax image, at least one of the plurality of switch regions is switched to lead the display region projects one of the left eye parallax image and the right eye parallax image, and the others of the plurality of switch regions shade the corresponding display regions which displays the other of the left eye parallax image and the right eye parallax image.

5. The autostereoscopic display device with partitioning backlight according to claim 1, wherein a switching speed of liquid crystals of the main display module is less than a switching speed of liquid crystals of the light shield module.

6. The autostereoscopic display device with partitioning backlight according to claim 1, wherein a light incident side of the main display module and the light shield module are stacked upon each other.

7. The autostereoscopic display device with partitioning backlight according to claim 1, wherein there is optical glue between the main display module and the light shield module, and there is no polarizer between the optical glue and a liquid crystal layer of the main display module.

8. The autostereoscopic display device with partitioning backlight according to claim 1, wherein there is optical glue between the main display module and the light shield module, and there is no polarizer between the optical glue and a liquid crystal layer of the light shield module.

9. The autostereoscopic display device with partitioning backlight according to claim 1, wherein the imaging semi-reflective mirror is a windshield or a combiner.

10. The autostereoscopic display device with partitioning backlight according to claim 1, wherein activation time of the switch region or activation time of the backlight source is controlled to correspond to preset brightness.

11. The autostereoscopic display device with partitioning backlight according to claim 1, wherein at least one of the plurality of display regions is collocated with the plurality of different backlight sources to project the image beam, another group of small eye boxes are defined outside space of the eye box array on a front side and a rear side of the backlight focal plane, and the another group of small eye boxes and the eye box array cooperatively form an extension eye box array.

12. The autostereoscopic display device with partitioning backlight according to claim 1, further comprising:
an eye tracking module detecting relative position information of a left eye, a right eye and the eye tracking module;
a control operation module connected to the backlight module, the display and the eye tracking module,
wherein, the control operation module is configured to obtain a left eye position and a right eye position according to the relative position information of the eye tracking module, obtain a left eye box and a right eye box according to the left eye position, the right eye position and the eye box array or the extension eye box array, obtain a left eye matrix and a right eye matrix according to a small eye box-display region-backlight source matrix table;
wherein, the left eye matrix and the right eye matrix comprises the corresponding display regions, the corresponding switch regions and the corresponding backlight sources;
wherein, the corresponding display regions, the corresponding switch regions and the corresponding backlight sources are configured to respectively project the image beam of the left eye parallax image and the image beam of the right eye parallax image on the left eye position and the right eye position.

13. The autostereoscopic display device with partitioning backlight according to claim 11, wherein the plurality of small eye boxes in the eye box array or the extension eye box array are switched to correspond to eye displacement comprising displacement in a 2D direction or a 3D direction.

14. The autostereoscopic display device with partitioning backlight according to claim 12, wherein the eye box array or the extension eye box array defines adjacent 2n+1 small eye boxes corresponding to the left eye position or the right eye position, while n>0 and n is a positive integer, a central small eye box of the 2n+1 small eye boxes corresponds to a pupil of the left eye or the right eye, and 2n small eye boxes are distributed on an upper side and a lower side of the central small eye box or a left side and a right side of the central small eye box.

15. The autostereoscopic display device with partitioning backlight according to claim 12, wherein a switching time interval of projecting the image beam on the same eye position by each of the plurality of display regions of the main display module is less than 41.67 ms.
